(19) United States
(12) Patent Application Publication
(10) Pub. No.: US 2016/0300433 A1
(43) Pub. Date: Oct. 13, 2016

(54) GRAPHICAL USER INTERFACE FOR ON-LINE GAMING

(71) Applicant: iPro, Inc., Incline Village, NV (US)

(72) Inventors: David ORTIZ, Newcastle, WA (US); Shanmugapriyan DEVARAJ, Portland, OR (US); Shanmugam CHINNASAMY, Bellevue, WA (US); Robert MELENDRES, Incline Village, NV (US)

(21) Appl. No.: 14/684,210

(22) Filed: Apr. 10, 2015

(51) Int. Cl. G07F 17/32

(52) U.S. Cl. CPC G07F 17/3211; G07F 17/3288; G07F 17/3225

(57) ABSTRACT

Graphical user interface for on-line gaming is disclosed. In accordance with a first embodiment of the present invention, a graphical user interface includes a representation of a playing field, a plurality of player icons on the representation of a playing field for selecting to wager on a specific player. Each of the player icons includes a player number. The graphical user interface also includes a plurality of player group icons on the representation of a playing field, located among a group of the player icons, for selecting to wager on a group of players represented by the group of the player icons. The player group icon lacks a player number. The graphical user interface further includes a countdown timer for displaying the duration of time remaining to make a wager.

### RELATED APPLICATIONS

This application is related to co-pending, commonly owned U.S. patent application Ser. No. ______, attorney docket IPRO-0001-01.01US, filed Apr. 10, 2015, entitled “Method and System for Seamless Transitions between Game Types for Portable Computer Systems” to Devaraj et al., and is hereby incorporated by reference herein in its entirety.

This application is related to co-pending, commonly owned U.S. patent application Ser. No. ______, attorney docket IPRO-0002-01.01US, filed Apr. 10, 2015, entitled “System and Method for Accepting and Creating Electronic Wagers” to Ortiz et al., and is hereby incorporated by reference herein in its entirety.

This application is related to co-pending, commonly owned U.S. patent application Ser. No. ______, attorney docket IPRO-0003-01.01US, filed Apr. 10, 2015, entitled “System and Method for On-line Wagering on Real Time Events” to Ortiz et al., and is hereby incorporated by reference herein in its entirety.

This application is related to co-pending, commonly owned U.S. patent application Ser. No. ______, attorney docket IPRO-0004-01.01US, filed Apr. 10, 2015, entitled “System and Method for On-line Fantasy Wagering” to Ortiz et al., and is hereby incorporated by reference herein in its entirety.

This application is related to co-pending, commonly owned U.S. patent application Ser. No. ______, attorney docket IPRO-0005-01.01US, filed Apr. 10, 2015, entitled “System and Method for On-Line Multi-Player Interactive Wagering” to Devaraj et al., and is hereby incorporated by reference herein in its entirety.

U.S. Pat. No. 8,790,176, entitled “System and Method for Real Time Interactive Entertainment” to Hopf and Ortiz, is hereby incorporated by reference herein in its entirety.

### FIELD OF INVENTION

Embodiments of the present invention relate to the field of electronic applications for mobile computer systems. More specifically, embodiments of the present invention relate to graphical user interfaces for on-line gaming.

### BACKGROUND

Conventional user interfaces for on-line wagering have been found lacking.

### SUMMARY OF THE INVENTION

Therefore, what is needed are graphical user interfaces for on-line gaming. What is additionally needed are graphical user interfaces for on-line gaming that are substantially similar for various types of wagering on sporting events. Further, a need exists for graphical user interfaces for on-line gaming that are compatible and complementary with existing systems and methods of on-line and/or mobile gaming. Embodiments of the present invention provide these advantages.

In accordance with a first embodiment of the present invention, a graphical user interface includes a representation of a playing field, a plurality of player icons on the representation of a playing field for selecting to wager on a specific player. Each of the player icons includes a player number. The graphical user interface also includes a plurality of player group icons on the representation of a playing field, located among a group of the player icons, for selecting to wager on a group of four players in closest proximity to the player group icon. The player group icon lacks a player number. The graphical user interface further includes a countdown timer for displaying a duration of time remaining to make a wager.

In accordance with another embodiment of the present invention, a graphical user interface for selecting team results of a micro event includes a run icon for wagering a micro event will be a running play, a pass icon for wagering the micro event will be a passing play, a plurality of yardage gained icons for wagering yardage gained on the micro event, and a plurality of play direction icons for wagering on a direction of the micro event. The plurality of yardage gained icons may include yardage gained icons for 0-3 yards, 4-8 yards, 9-35 yards, and 36-100 yards. The plurality of play direction icons may include play direction icons for a play to the left hash, a play up the middle, and a play to the right hash.

In accordance with a further embodiment of the present invention, a graphical user interface for displaying a play recap includes a post wager marker displayed over a selected betting icon. The selected betting icon was selected to make a wager. The graphical user interface further includes a play result display summarizing a position taken on a micro event. The play result display includes a textual statement of the position taken on a micro event.

### BRIEF DESCRIPTION OF THE DRAWINGS

The accompanying drawings, which are incorporated in and form a part of this specification, illustrate embodiments of the invention and, together with the description, serve to explain the principles of the invention. Unless otherwise noted, the drawings are not drawn to scale.

FIG. 1 illustrates an exemplary block diagram of an exemplary electronic system, which may be used as a platform to implement embodiments of the present invention.

FIG. 2 illustrates an exemplary graphical user interface for player wagering, in accordance with embodiments of the present invention.

FIG. 3 illustrates an exemplary graphical user interface for first down wagering, in accordance with embodiments of the present invention.

FIG. 4 illustrates an exemplary graphical user interface for field goal wagering, in accordance with embodiments of the present invention.

FIG. 5 illustrates an exemplary graphical user interface for touchdown wagering, in accordance with embodiments of the present invention.

FIG. 6 illustrates an exemplary graphical user interface for offensive player group wagering, in accordance with embodiments of the present invention.

FIG. 7 illustrates an exemplary graphical user interface for individual offensive player wagering, in accordance with embodiments of the present invention.

FIG. 8 illustrates an exemplary graphical user interface for quarterback wagering, in accordance with embodiments of the present invention.

FIG. 9 illustrates an exemplary graphical user interface for team sack wagering, in accordance with embodiments of the present invention.

FIG. 10 illustrates an exemplary graphical user interface for team turnover wagering, in accordance with embodiments of the present invention.

FIG. 11 illustrates an exemplary graphical user interface for defensive score wagering, in accordance with embodiments of the present invention.

FIG. 12 illustrates an exemplary graphical user interface for defensive player group wagering, in accordance with embodiments of the present invention.

FIG. 13 illustrates an exemplary graphical user interface for individual defensive player wagering, in accordance with embodiments of the present invention.

FIG. 14 illustrates an exemplary graphical user interface for selecting team results of a micro event, in accordance with embodiments of the present invention.

FIG. 15 illustrates an exemplary graphical user interface for team pass wagering, in accordance with embodiments of the present invention.

FIG. 16 illustrates an exemplary graphical user interface for team run wagering, in accordance with embodiments of the present invention.

FIG. 17 illustrates an exemplary graphical user interface for team gain 0-3 yards wagering, in accordance with embodiments of the present invention.

FIG. 18 illustrates an exemplary graphical user interface for team gain 4-8 yards wagering, in accordance with embodiments of the present invention.

FIG. 19 illustrates an exemplary graphical user interface for team gain 9-35 yards wagering, in accordance with embodiments of the present invention.

FIG. 20 illustrates an exemplary graphical user interface for team gain 36-100 yards wagering, in accordance with embodiments of the present invention.

FIG. 21 illustrates an exemplary graphical user interface for team left hash wagering, in accordance with embodiments of the present invention.

FIG. 22 illustrates an exemplary graphical user interface for team middle of the field wagering, in accordance with embodiments of the present invention.

FIG. 23 illustrates an exemplary graphical user interface for team right hash wagering, in accordance with embodiments of the present invention.

FIG. 24 illustrates an exemplary graphical user interface for betting on a micro event when a duration between plays is decreased, in accordance with embodiments of the present invention.

FIG. 25 illustrates an exemplary graphical user interface for displaying a play recap, in accordance with embodiments of the present invention.

FIG. 26 illustrates an exemplary graphical user interface for displaying a pick history, in accordance with embodiments of the present invention.

FIGS. 27A, 27B, 27C and 27D illustrates first through fourth conditions of an exemplary graphical user interface for displaying results of a wager, in accordance with embodiments of the present invention.

FIG. 28 illustrates an exemplary graphical user interface (GUI) for player wagering, in accordance with embodiments of the present invention.

FIG. 29 illustrates an exemplary graphical user interface (GUI) for initiating a side bet, in accordance with embodiments of the present invention.

### DETAILED DESCRIPTION

Reference will now be made in detail to various embodiments of the present invention, examples of which are illustrated in the accompanying drawings. While the invention will be described in conjunction with these embodiments, it is understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the invention, numerous specific details are set forth in order to provide a thorough understanding of the invention. However, it will be recognized by one of ordinary skill in the art that the invention may be practiced without these specific details. In other instances, well known methods, procedures, components, and circuits have not been described in detail as not to unnecessarily obscure aspects of the invention.

### Notation and Nomenclature

The terms “micro event” and “sub-event” are used to refer to or to describe an activity within a larger “event,” the outcome of which may be subject to a wager. The event must be occurring at present or in the future, and the outcome(s) of the event and its micro events must be unknown at the present. For example, a football game may be considered an “event,” while individual plays within the game may be considered “micro events.” Similarly, a baseball game may be considered an “event,” while each pitch, and the resulting outcome, e.g., ball, strike, single, double, triple, home run, sacrifice fly, etc., may be considered a “micro event.” For games with a less defined play structure, e.g., basketball, hockey, or soccer, a fixed duration of game time, e.g., five minutes, may constitute a “micro event.” Embodiments in accordance with the present invention are well suited to wagers based on events and micro events within such events.

### Graphical User Interface for On-Line Gaming

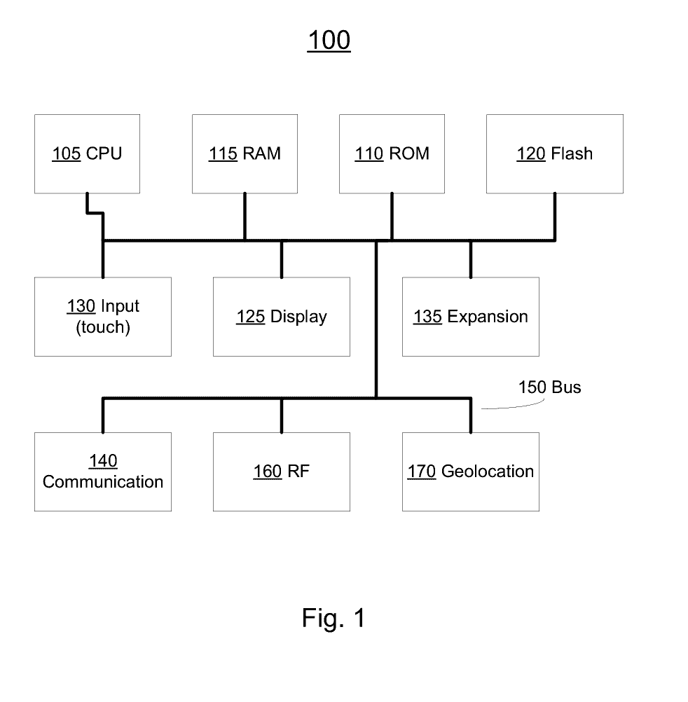

FIG. 1 illustrates an exemplary block diagram of an exemplary electronic system 100, which may be used as a platform to implement embodiments of the present invention. Electronic system 100 may be battery-powered, in some embodiments. Electronic system 100 may be a “server” computer system, in some embodiments. Electronic system 100 may comprise a desktop or generally “fixed location” computer system, in some embodiments. Electronic system 100 may comprise a portable computer system, e.g., a “smart” phone. Electronic system 100 may comprise a “wearable” computer system, e.g., a “smart” watch or an “eye-glass-mounted” computer system. Electronic system 100 includes an address/data bus 150 for communicating information, a central processor 105 functionally coupled with the bus for processing information and instructions. Central processor 105 may comprise a single processor or multiple processors, e.g., a multi-core processor, or multiple separate processors, in some embodiments. Electronic system 100 also includes a volatile memory 115 (e.g., random access memory RAM) coupled with the bus 150 for storing information and instructions for the central processor 105, and a non-volatile memory 110 (e.g., read only memory ROM) coupled with the bus 150 for storing static information and instructions for the processor 105. Electronic system 100 also optionally includes a changeable, non-volatile memory 120 (e.g., flash) for storing information and instructions for the central processor 105 which can be updated after the manufacture of system 100. In some embodiments, only one of ROM 110 or Flash 120 may be present.

Also included in electronic system 100 of FIG. 1 is an optional input device 130. Device 130 can communicate information and command selections to the central processor 100. Input device 130 may be any suitable device for communicating information and/or commands to the electronic system 100. For example, input device 130 may take the form of a keyboard, buttons, a joystick, a track ball, an audio transducer, e.g., a microphone, a touch sensitive digitizer panel, eyeball scanner, and/or the like. A touch sensitive digitizer panel may comprise any suitable technology, e.g., capacitive, resistive, optical, acoustic and/or pressure responsive touch panels. Activation of a “touch” sensitive digitizer panel may not require actual touching of the panel 130 or the electronic system 100, in some embodiments. For example, capacitive touch panels may sense proximity of a user's finger or an eyeball scanner may detect a direction of a user's gaze.

The display unit 125 utilized with the electronic system 100 may comprise a liquid crystal display (LCD) device, cathode ray tube (CRT), field emission device (FED, also called flat panel CRT), light emitting diode (LED), plasma display device, electro-luminescent display, electronic paper, electronic ink (e-ink) or other display device suitable for creating graphic images and/or alphanumeric characters recognizable to the user. Display unit 125 may have an associated lighting device, in some embodiments. Display unit 125 may comprise a head-mounted display, in some embodiments.

The touch sensitive digitizer panel 130 is generally associated with the display unit 125. For example, a function of the touch sensitive digitizer panel 130 generally associated with the display unit 125 is to localize a touch input, e.g., from a finger or stylus, to a portion of display unit 125, for example, a single icon image displayed on display unit 125. The touch sensitive digitizer panel may be in front of the actual display device, e.g., in a viewer's optical path, or the touch sensitive digitizer panel may be outside of a viewer's optical path, e.g., behind or to the side of the display device. The touch sensitive digitizer panel 130 may have different planar dimensions in comparison to planar dimensions of a display unit 125. For example, the touch sensitive digitizer panel 130 may be smaller than display unit 125, e.g., the display unit 125 may extend beyond the touch sensitive digitizer panel 130. Similarly, the touch sensitive digitizer panel 130 may be larger than display unit 125, e.g., the touch panel may extend beyond the display unit. The touch sensitive digitizer panel may be integral to a display assembly, or a separate assembly within the electronic system 100. A touch sensitive digitizer panel is not required.

Electronic system 100 also optionally includes an expansion interface 135 coupled with the bus 150. Expansion interface 135 can implement many well known standard expansion interfaces, including without limitation the Secure Digital Card interface, universal serial bus (USB) interface, Compact Flash, Personal Computer (PC) Card interface, CardBus, Peripheral Component Interconnect (PCI) interface, Peripheral Component Interconnect Express(PCI Express), mini-PCI interface, IEEE 1394, Small Computer System Interface (SCSI), Personal Computer Memory Card International Association (PCMCIA) interface, Industry Standard Architecture (ISA) interface, RS-232 interface, and/or the like. In some embodiments of the present invention, expansion interface 135 may comprise signals substantially compliant with the signals of bus 150.

A wide variety of well-known devices may be attached to electronic system 100 via the bus 150 and/or expansion interface 135. Examples of such devices include without limitation rotating magnetic memory devices, flash memory devices, digital cameras, wireless communication modules, digital audio players, and Global Positioning System (GPS) devices.

System 100 also optionally includes a communication port 140. Communication port 140 may be implemented as part of expansion interface 135. When implemented as a separate interface, communication port 140 may typically be used to exchange information with other devices via communication-oriented data transfer protocols. Examples of communication ports include without limitation RS-232 ports, universal asynchronous receiver transmitters (UARTs), USB ports, infrared light transceivers, ethernet ports, IEEE 1394, and synchronous ports.

System 100 optionally includes a radio frequency module 160, which may implement a mobile telephone, a wireless network, e.g., IEEE 802.11 (“Wi-Fi”), Bluetooth, a pager, or a digital data link. Radio frequency module 160 may be interfaced directly to bus 150, via communication port 140, via expansion interface 135, or any suitable interface. Various features of electronic system 100 may be implemented by a combination of hardware and/or software. Electronic system 100 may comprise additional software and/or hardware features (not shown) in some embodiments.

Various modules of system 100 may access computer readable media, and the term is known or understood to include removable media, for example, Secure Digital (“SD”) cards, CD and/or DVD ROMs, diskettes and the like, as well as non-removable or internal media, for example, hard drives, RAM, ROM, flash, and the like.

Electronic system 100 may comprise one or more geolocation determining features 170. For example, electronic system 100 may determine its position by use of a Global Positioning System (GPS), including, for example, the United States Global Position System, the planned European Union Galileo positioning system, India's Indian Regional Navigational Satellite System and/or the Chinese Compass navigation system. Electronic system 100 may also determine its position via a mobile telephone network, for example, identifying, measuring signal strength, and/or triangulation of cell towers. Electronic system 100 may also determine its position from known locations of wireless networks, e.g., WiFi hotspots, from an internet protocol (IP) address, or any other applicable location service(s). Geolocation determining features 170 may comprise dedicated hardware, or may utilize components with one or more other uses.

In accordance with embodiments of the present invention, a gaming application program running on an embodiment of electronic system 100 automatically determines the device's geolocation. While embodiments in accordance with the present invention are generally disclosed using examples of portable computer systems, e.g., “smart phones,” a device's geolocation should be determined even if the electronic system is of a type not generally considered to be portable, e.g., a “desk top” computer system, in accordance with embodiments of the present invention. Based on the geolocation, the device automatically and transparently to the user switches among at least two different types of games. For example, the types of games may include real money gambling, social points gambling, and/or fantasy gambling. Co-pending, commonly owned U.S. patent application Ser. No. ______, attorney docket IPRO-0001-01.01US, filed Apr. 10, 2015, entitled “Method and System for Seamless Transitions between Game Types for Portable Computer Systems” to Devaraj et al., incorporated by reference herein in its entirety, discloses further information on determining a legal jurisdiction for wagering.

When the electronic system 100 is located within a jurisdiction that does not allow gambling, only non-gambling types of games, e.g., games for social points, are made available to the user. When the electronic system 100 is located within a jurisdiction that does allow gambling, then real money gambling is made available to the user. It is appreciated that not all jurisdictions that allow some types of gambling allow all types of gambling. For example, some jurisdictions allow “real money” wagering on “games of skill,” e.g., “fantasy sports,” while prohibiting “real money” wagering on “games of chance,” e.g., singular outcomes. Accordingly, embodiments in accordance with the present invention may provide further granularity as to types of games. For example, based on the laws of a particular jurisdiction, a device may switch among more than one type of real money gambling, e.g., based on a type of wager, in addition to social points gaming.

In accordance with embodiments of the present invention, players of an on-line gaming application may bet directly against one another, or a third party, e.g., an on-line casino, and/or gaming host. Game play may comprise a series of wagers on micro events within live sporting events or other live events that comprise a series of micro events. For example, many sporting events, e.g., football and baseball games, comprise numerous plays. Other sporting events, e.g., basketball, hockey and soccer games, may be sub-divided into time segments, for example, 5 minutes of game play. Such plays or time segments may be considered micro events.

In accordance with embodiments of the present invention, real money wagers may be placed on individual micro events of a sporting contest. In accordance with embodiments of the present invention, real money wagers may be placed on more than one, e.g., a series of, micro events of a sporting contest. A payout of real currency may be based on an accumulated score of a series of wagers on a series of micro events. This form of gambling is generally known as or referred to as “fantasy” gambling, and may be played for real or virtual currency. Co-pending, commonly owned U.S. patent application Ser. No. ______, attorney docket IPRO-0004-01.01US, filed Apr. 10, 2015, entitled “System and Method for On-line Fantasy Wagering” to Ortiz et al., incorporated by reference herein in its entirety, provides additional disclosures related to fantasy gaming.

The following graphical user interfaces facilitate real currency and/or virtual currency wagering on a single micro event and/or a series of micro events, in accordance with embodiments of the present invention. The graphical user interfaces are substantially similar for each type of gaming. For example, social points wagering utilizes substantially the same graphical user interfaces as real money gaming, and real money fantasy gaming utilizes substantially the same graphical user interfaces as real money gaming.

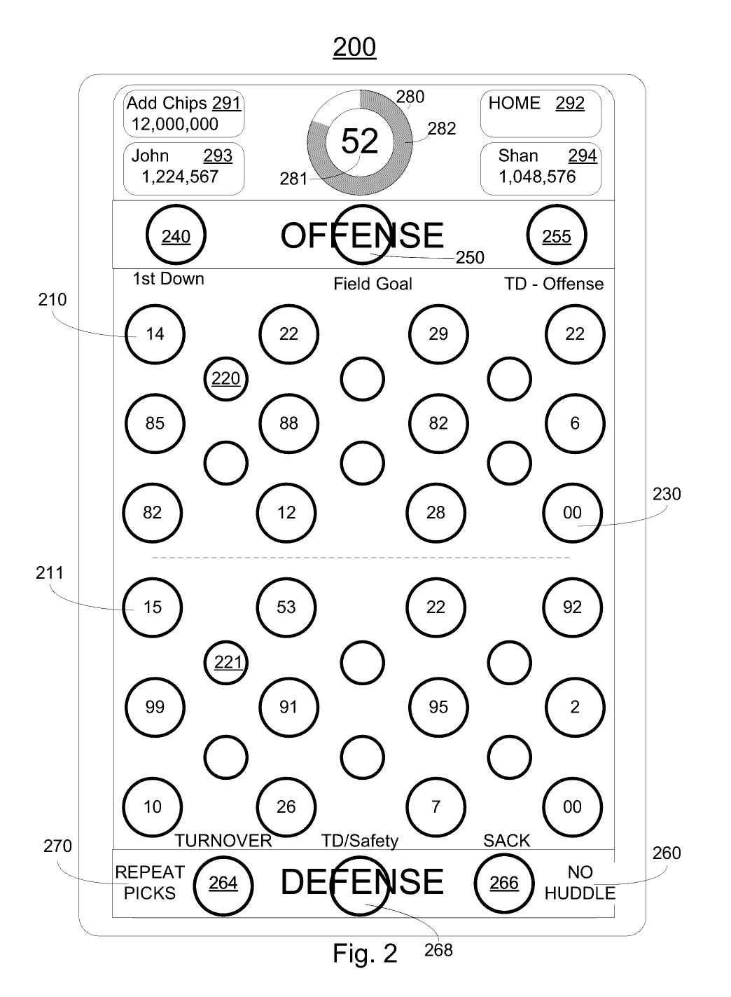

FIG. 2 illustrates an exemplary graphical user interface (GUI) 200 for player wagering, in accordance with embodiments of the present invention. In the exemplary embodiment of FIG. 2, the display 200 is configured for wagering on players performance in micro events in a football contest. Embodiments in accordance with the present invention are well suited to wagering on micro events in other sporting contests. Approximately the top half of display 200 is for taking positions on players and micro events related to the offensive team, while approximately the bottom half of display 200 is for taking positions on players and micro events related to the defensive team. Display 200 comprises a plurality of player icons, e.g., player icon 210, comprising a circle outlining a player number. Generally, in graphical user interface 200 and the graphical user interfaces to follow, a hollow circle represents a wagering opportunity. For example, wherever a hollow circle appears, e.g., player icon 210, touching the hollow circle initiates a bet.

Each player icon represents the player with that number that plays at approximately that position. For example, the number 14 may generally correspond to a quarterback, punter, or place kicker. Selecting a player icon, e.g., by touching the icon, will initiate a subsequent display to select specific details of an upcoming play, e.g., a micro event, involving the player indicted by the player icon. Player icons, e.g., player icon 211, are presented for defensive players, as well. An example wager on a defensive player and micro event may be on which player will tackle a ball carrier, or on which player will intercept a pass.

Display 200 also comprises a plurality of player group icons, e.g., player group icon 220. A player group icon comprises a circle among the offensive and defensive player icons that does not enclose a number. A player group icon represents a group of four players in closest proximity to the player group icon. For example, player group icon 220 represents players 14, 22, 85 and 88. Selecting a player group icon, e.g., by touching the icon, will initiate a different display to select specific details of an upcoming play, e.g., a micro event, involving one or more of the players indicted by the player group icon. Player group icons, e.g., player group icon 221, are presented for groups of defensive players, as well.

Player icon 230, referring to player “00,” is a special case. Player icon 230 does not refer to a player wearing number “00.” Rather, player icon 230 refers to an offensive player other than the players indicated in the other offensive player icons. For example, the numbers in the player icons may refer to the players that start a game. In many sporting contests, including football, players may substitute, sometimes on a play-by-play basis. Accordingly, player icon 230 represents any player, possibly a substitute player, that is not represented by another player icon, e.g., has a different number than a displayed player icon. Player icon 230 is known as or referred to as a “wild card.”

Display 200 comprises a plurality of offensive team result icons, e.g., 1st down icon 240, field goal icon 250, and touchdown-offense icon 255. Offensive team result icons represent play results, e.g., micro events, which are more generalized than the play results associated with player icons and/or player group icons. For example, 1st down icon 240 represents a position on whether the offensive team will achieve a first down by any type of play involving any player(s). Field goal icon 250 represents a position that the offensive team will score a field goal, and touchdown-offense icon 255 represents a position that the offense will score a touchdown.

Display 200 also comprises a plurality of defensive team result icons, e.g., turnover icon 264, sack icon 266, and touchdown/safety icon 268. Defensive team result icons represent play results, e.g., micro events, which are more generalized than the play results associated with player icons and/or player group icons. For example, turnover icon 264 represents a position that the defense will recover a turnover, e.g., a fumble or an interception. Touchdown safety icon 268 represents a position that the defense will score, for example, via an interception return for a touchdown, e.g., a “pick six,” or a safety. Sack icon 266 represents a position that the defense will tackle an offensive player, typically the quarterback, who is attempting to pass, for a loss.

Display 200 also comprises a repeat picks field 270. Repeat picks field 270 may be used to repeat the wager on a play, e.g., a micro event, that was selected for the immediately preceding play. Display 200 further comprises a no huddle field 260. Touching no huddle field 260 initiates a different, e.g., streamlined, version of a graphical user interface for use when a duration between plays is decreased, for example, when a player might not have enough time to select details of a micro event according to graphical user interface 200, e.g., when the offense is playing a “no huddle” style of play.

Display 200 further comprises a countdown timer display 280. Countdown timer display 280 displays a time remaining to complete selection of a position for a next micro event. Countdown timer display 280 comprises a numeric display 281 of a time remaining to complete selection of a position for a next micro event, e.g., in seconds. Countdown timer display 280 also comprises an annular graphic display 282 of a time remaining to complete selection of a position for a next micro event. Annular graphic display 282 indicates a time remaining as a filled fraction of an annular ring. For example, a filled portion of annular graphic display 282 may decrease by one part in 60 for each second of decrease in time remaining to complete selection of a position for a next micro event. In some embodiments, countdown timer display 280 may reset to a play clock or shot clock, e.g., to a time remaining that is less than one minute, e.g., less than a full annular ring. Annular graphic display 282 may decrease in a counter-clockwise direction, in some embodiments. The filled portion of annular graphic display 282 may change color, e.g., to red, at a threshold time, e.g., 10 seconds, to indicate a critical time remaining to enter a position, in some embodiments. The inner circle of countdown timer display 280 may be filled with a color, e.g., orange, at a threshold time, e.g., 10 seconds, to indicate a critical time remaining to enter a position, in some embodiments. Other visual attention grabbing mechanisms are well suited to use with countdown timer display 280, including, for example, flashing elements of countdown timer display 280, e.g., numerical display 281, reversing text and/or graphics colors, and the like, in some embodiments.

Display 200 also comprises a display 293 of a current player's holdings, e.g., in real currency or a virtual currency, e.g., fantasy or social points or chips. Display 200 also comprises a display 294 of an opponent's holdings. Display 294 may display an opponent, from a group of opponents, with a highest score, in some embodiments. Touching display 294 may present a list (not shown) of all opponents. Touching a particular opponent in such a list may cause that particular opponent to be displayed in display 294, in some embodiments.

In addition, display 200 comprises an add chips icon 291 to add currency, e.g., real currency or a virtual currency, e.g., fantasy or social points or chips, to a player's holdings. Add chips icon 291 may operate as a “rebuy” function, in some embodiments. In accordance with embodiments of the present invention, a user may not be able to add chips in all situations. For example, in a game with an entry fee, e.g., a fantasy game, users are generally not able to, or required to, submit a second entry fee, which may be the equivalent of adding chips in that circumstance. In addition, some games may limit a number of rebuys in a single wagering game. Further, user credit and/or user account balance considerations may prevent a user from adding chips. In such situations, add chips icon 291 may not be presented, in accordance with embodiments of the present invention.

Further, display 200 comprises a home icon 292 to take a player to a home screen. Home icon 292 may also display a symbolic indication of location within a multi-level graphical user interface, in some embodiments.

Some legal jurisdictions do not allow real money fantasy wagers on a team basis. For example, such wagers must involve a specific player. Under such circumstances, touchdown-offense icon 255, and team defense icons, e.g., turnover icon 264, sack icon 266, and touchdown/safety icon 268, may not be presented in graphical user interface 200. The 1st down icon 240 and field goal icon 250 will be tied to specific players in subsequent wager displays.

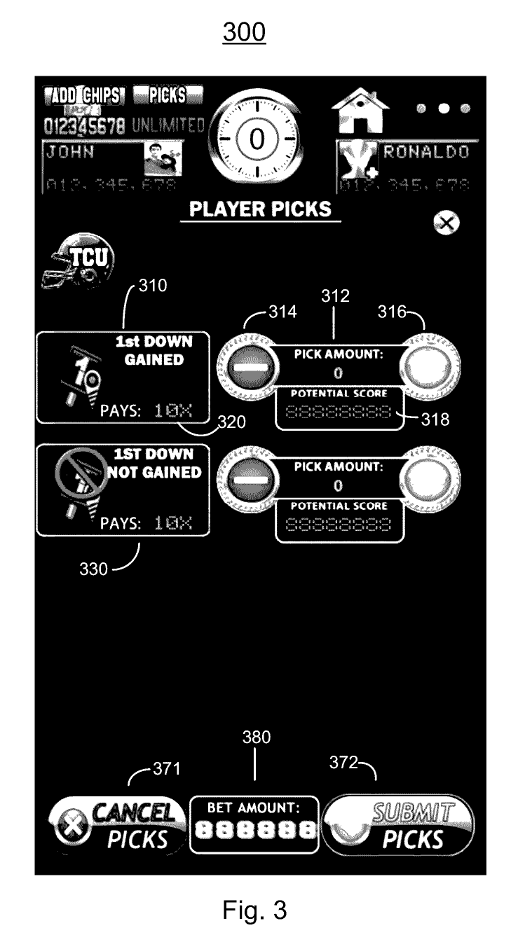

FIG. 3 illustrates an exemplary graphical user interface (GUI) 300 for first down wagering, in accordance with embodiments of the present invention. Graphical user interface 300 for first down wagering may be displayed, for example, in response to a user touching 1st down icon 240 of FIG. 2. Display 310 comprises a 1st down gained display 310. Display 310 indicates a payout factor 320 for a wager that the offense will gain a first down. For example, if the offense gains a first down, a wager will pay 10 times the amount wagered. Display 300 comprises a pick amount field 312, associated with 1st down gained display 310. Pick amount field 312 displays an amount of a bet and allows a user to change an amount of the bet. For example, a pick amount may be increased by touching plus button 316, and decreased by touching minus button 314. Pick amount field 312 may also operate as a slider, in some embodiments, e.g., moving a finger touching within pick amount field 312, toward plus button 316 increases a wager amount, while moving a finger toward minus button 314 decreases a pick amount. Display 300 further comprises a potential score display 318. Potential score display 318 displays a potential payout if a first down is gained, based on the pick amount 312 and the payout factor 320.

Display 300 also comprises a 1st down not gained display 330. Display 330 indicates a payout factor for a wager that the offense will not gain a first down. For example, if the offense does not gain a first down, a wager will pay 10 times the amount wagered. Display 300 further comprises a pick amount field and a potential score display associated with 1st down not gained display 330. The pick amount field and potential score display associated with 1st down not gained display 330 operate in a similar manner to that of pick amount field 312 and potential score display 318.

If the wagering game is real money fantasy wagering, a specific player number, e.g., the player number of a running back, will be displayed on graphical user interface 300, along with text generally of the form, “Player number ### gains a first down.”

In accordance with embodiments of the present invention, the amounts displayed in a pick amount field and a potential score display may be in a real currency, e.g., U.S. Dollars (“$”), or in a virtual currency, e.g., social or fantasy points, or “chips.” In accordance with embodiments of the present invention, a user may enter a pick amount in both exemplary fields. For example, a user may wager both that a first down is gained, and that a first down is not gained. For example, if a user bets different amounts on each event, such a combination may represent a “hedge” on the outcome.

Graphical user interface 300 further comprises a cancel button 371, a submit button 372 and a “bet amount” field 380. Bet amount field 380 displays the total amount, e.g., in points, a user will bet, e.g., be at risk, if the bet is placed. Touching or otherwise indicating cancel button 371 terminates the current creation of a bet. Touching or otherwise indicating submit button 372 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

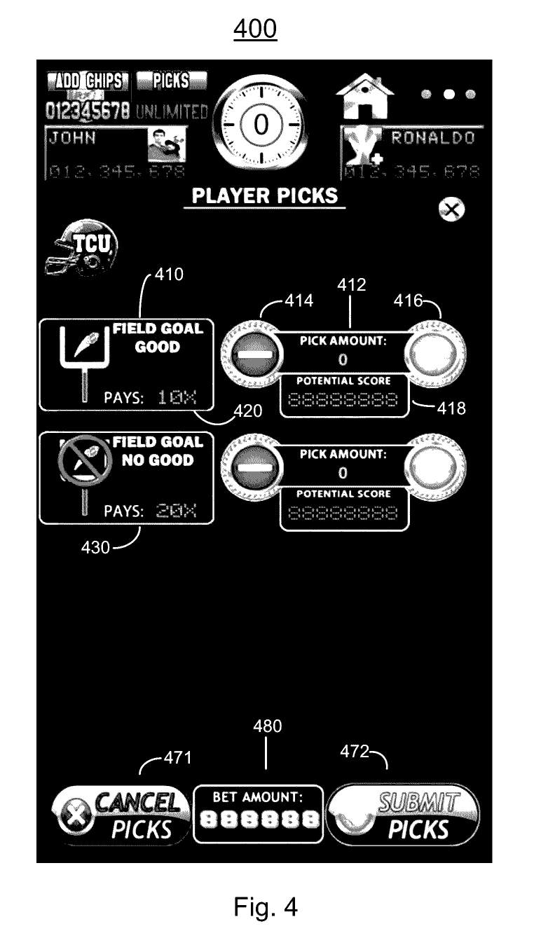

FIG. 4 illustrates an exemplary graphical user interface (GUI) 400 for field goal wagering, in accordance with embodiments of the present invention. Graphical user interface 400 for field goal wagering may be displayed, for example, in response to a user touching field goal icon 250 of FIG. 2. Display 410 comprises a field goal good display 410. Display 410 indicates a payout factor 420 for a wager that the offense will successfully execute a field goal. For example, if the offense makes a field goal, a wager will pay 10 times the amount wagered. Display 400 comprises a pick amount field 412, associated with field goal good display 410. Pick amount field 412 displays an amount of a bet and allows a user to change an amount of the bet. For example, a pick amount may be increased by touching plus button 416, and decreased by touching minus button 414. Pick amount field 412 may also operate as a slider, in some embodiments, e.g., moving a finger touching within pick amount field 412, toward plus button 416 increases a wager amount, while moving a finger toward minus button 414 decreases a pick amount. Display 400 further comprises a potential score display 418. Potential score display 418 displays a potential payout if a field goal is made, based on the pick amount 412 and the payout factor 420.

Display 400 also comprises a field goal not good display 430. Display 430 indicates a payout factor for a wager that the offense will not make a field goal. For example, if the offense does not make a field goal, a wager will pay 20 times the amount wagered. Display 400 further comprises a pick amount field and a potential score display associated with field goal not gained display 430. The pick amount field and potential score display associated with field goal not good display 430 operate in a similar manner to that of pick amount field 412 and potential score display 418.

If the wagering game is real money fantasy wagering, a specific player number, e.g., the player number of a place kicker, will be displayed on graphical user interface 400, along with text generally of the form, “Player number ### attempts a field goal.”

In accordance with embodiments of the present invention, the amounts displayed in a pick amount field and a potential score display may be in a real currency, e.g., British Pounds (“ [symbol] ”), or in a virtual currency, e.g., social or fantasy points, or “chips.” In accordance with embodiments of the present invention, a user may enter a pick amount in both exemplary fields. For example, a user may wager both that a field goal is made, and that a field goal is not made. For example, based on different payout factors for the two wagers, a user may increase a probability of a payout by betting on both possible outcomes.

Graphical user interface 400 further comprises a cancel button 471, a submit button 472 and a “bet amount” field 480. Bet amount field 480 displays the total amount, e.g., in points, a user will bet, e.g., be at risk, if the bet is placed. Touching or otherwise indicating cancel button 471 terminates the current creation of a bet. Touching or otherwise indicating submit button 472 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

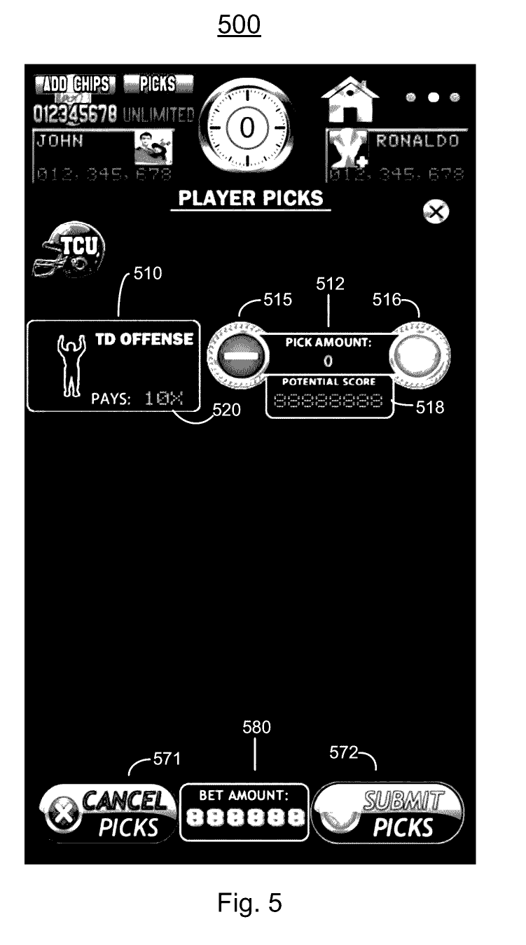

FIG. 5 illustrates an exemplary graphical user interface (GUI) 500 for touchdown wagering, in accordance with embodiments of the present invention. Graphical user interface 500 for touchdown wagering may be displayed, for example, in response to a user touching touchdown icon 255 of FIG. 2. Display 500 comprises a touchdown display 510. Touchdown display 510 indicates a payout factor 520 for a wager that the offense will successfully execute a touchdown. For example, if the offense makes a touchdown, a wager will pay 10 times the amount wagered. Display 500 comprises a pick amount field 512, associated with touchdown display 510. Pick amount field 512 displays an amount of a bet and allows a user to change an amount of the bet. For example, a pick amount may be increased by touching plus button 516, and decreased by touching minus button 514. Pick amount field 512 may also operate as a slider, in some embodiments, e.g., moving a finger touching within pick amount field 512, toward plus button 516 increases a wager amount, while moving a finger toward minus button 514 decreases a pick amount. Display 500 further comprises a potential score display 518. Potential score display 518 displays a potential payout if a touchdown is made, based on the pick amount 512 and the payout factor 520.

If the wagering game is real money fantasy wagering, a specific player number will be displayed on graphical user interface 500, along with text generally of the form, “Player number ### scores a touchdown.”

In accordance with embodiments of the present invention, the amounts displayed in a pick amount field and a potential score display may be in a real currency, e.g., Euros (“ [symbol] ”), or in a virtual currency, e.g., social or fantasy points, or “chips.”

Graphical user interface 500 further comprises a cancel button 571, a submit button 572 and a “bet amount” field 580. Bet amount field 580 displays the total amount, e.g., in points, a user will bet, e.g., be at risk, if the bet is placed. Touching or otherwise indicating cancel button 571 terminates the current creation of a bet. Touching or otherwise indicating submit button 572 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

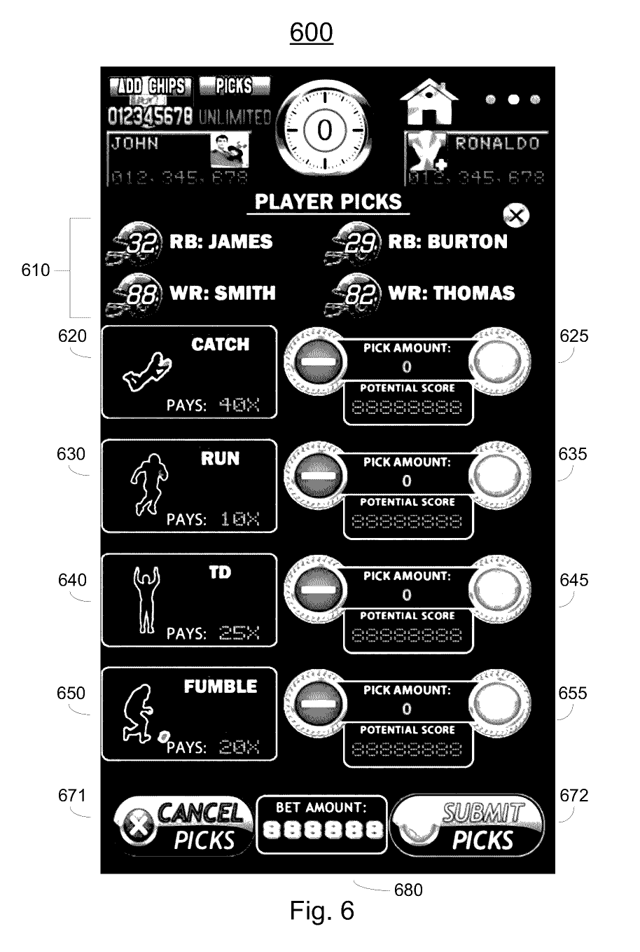

FIG. 6 illustrates an exemplary graphical user interface (GUI) 600 for offensive player group wagering, in accordance with embodiments of the present invention. Graphical user interface 600 for offensive player group wagering may be displayed, for example, in response to a user touching an offensive player group icon, e.g., player group icon 220 of FIG. 2. For example, a player group icon amongst players 32, 29, 88, and 82 was selected. Display 610 of graphical user interface 600 indicates the four players selected for the position on a micro event. Graphical user interface 600 comprises a catch display 620. Catch display 620 indicates a payout factor for a wager that one or more of the particular group of players, e.g., players 32, 29, 88, and/or 82, will be involved in a pass reception. For example, if one of the four players catches a pass, a wager will pay 40 times the amount wagered. Graphical user interface 600 also comprises a pick amount field and potential score display 625 associated with catch display 620. The functions and operations of pick amount field and potential score display 625 are similar to pick amount field 512 and potential score display 518 of FIG. 5. For example, pick amount field and potential score display 625 displays and enables a selection of a wager amount on a catch, and a display of a potential score, factoring in a payout factor, should one of the four specific players make a catch.

Graphical user interface 600 comprises a run display 630. Run display 620 indicates a payout factor for a wager that one or more of the particular group of players, e.g., players 32, 29, 88, and/or 82, will run the ball. For example, if one of the four players runs the ball, a wager will pay 10 times the amount wagered. Graphical user interface 600 also comprises a pick amount field and potential score display 635 associated with run display 620. The functions and operations of pick amount field and potential score display 635 are similar to pick amount field 512 and potential score display 518 of FIG. 5. For example, pick amount field and potential score display 635 displays and enables a selection of a wager amount on a running play, and a display of a potential score, factoring in a payout factor, should one of the four specific players run the ball.

Graphical user interface 600 comprises a touchdown display 640. Touchdown display 640 indicates a payout factor for a wager that one or more of the particular group of players, e.g., players 32, 29, 88, and/or 82, will score a touchdown. For example, if one of the four players scores a touchdown, a wager will pay 25 times the amount wagered. Graphical user interface 600 also comprises a pick amount field and potential score display 645 associated with touchdown display 640. The functions and operations of pick amount field and potential score display 645 are similar to pick amount field 512 and potential score display 518 of FIG. 5. For example, pick amount field and potential score display 645 displays and enables a selection of a wager amount on a touchdown, and a display of a potential score, factoring in a payout factor, should one of the four specific players score a touchdown.

Graphical user interface 600 comprises a fumble display 650. Fumble display 650 indicates a payout factor for a wager that one or more of the particular group of players, e.g., players 32, 29, 88, and/or 82, will fumble. For example, if one of the four players fumbles, a wager will pay 20 times the amount wagered. Graphical user interface 600 also comprises a pick amount field and potential score display 655 associated with fumble display 650. The functions and operations of pick amount field and potential score display 655 are similar to pick amount field 512 and potential score display 518 of FIG. 5. For example, pick amount field and potential score display 655 displays and enables a selection of a wager amount on a fumble, and a display of a potential score, factoring in a payout factor, should one of the four specific players fumble.

In accordance with embodiments of the present invention, the amounts displayed in a pick amount field and a potential score display may be in a real currency, e.g., Japanese Yen (“¥”), or in a virtual currency, e.g., social or fantasy points, or “chips.”

Graphical user interface 600 further comprises a cancel button 671, a submit button 672 and a “bet amount” field 680. Bet amount field 680 displays the total amount, e.g., in points, a user will bet, e.g., be at risk, if the bet is placed. Touching or otherwise indicating cancel button 671 terminates the current creation of a bet. Touching or otherwise indicating submit button 672 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

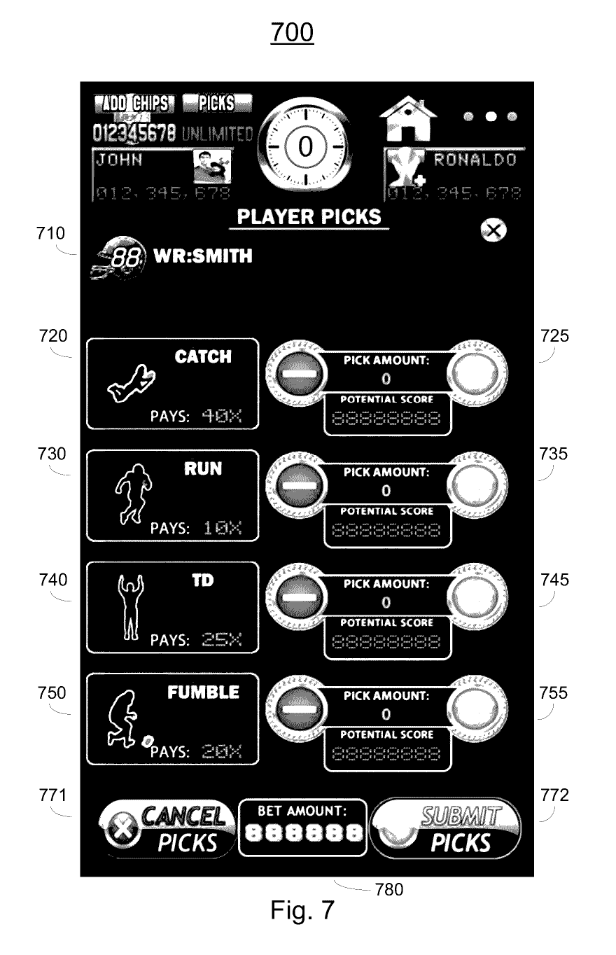

FIG. 7 illustrates an exemplary graphical user interface (GUI) 700 for individual offensive player wagering, in accordance with embodiments of the present invention. Graphical user interface 700 for individual offensive player wagering may be displayed, for example, in response to a user touching a player icon, e.g., player icon 210 of FIG. 2. Graphical user interface 700 for individual offensive player wagering may also be displayed, for example, in response to a user touching a “wild card” player icon, e.g., wild card player icon 230 of FIG. 2 for player “00.” In such a case, the subsequent described items refer to any player whose number is not displayed on graphical user interface 200 of FIG. 2. Display 710 of graphical user interface 700 indicates an individual offensive player, e.g., player number 88, selected for the position on a micro event. Graphical user interface 700 comprises a catch display 720. Catch display 720 indicates a payout factor for a wager that the individual player, e.g., player number 88, will be involved in a pass reception. For example, if the individual player catches a pass, a wager will pay 40 times the amount wagered. Graphical user interface 700 also comprises a pick amount field and potential score display 725 associated with catch display 720. The functions and operations of pick amount field and potential score display 725 are similar to pick amount field 512 and potential score display 518 of FIG. 5. For example, pick amount field and potential score display 725 displays and enables a selection of a wager amount on a catch, and a display of a potential score, factoring in a payout factor, should the individual player make a catch.

Graphical user interface 700 comprises a run display 730. Run display 730 indicates a payout factor for a wager that the individual player will run the ball. For example, if the individual player runs the ball, a wager will pay 10 times the amount wagered. Graphical user interface 700 also comprises a pick amount field and potential score display 735 associated with run display 730. The functions and operations of pick amount field and potential score display 735 are similar to pick amount field 512 and potential score display 518 of FIG. 5. For example, pick amount field and potential score display 735 displays and enables a selection of a wager amount on a running play, and a display of a potential score, factoring in a payout factor, should the individual player run the ball.

Graphical user interface 700 comprises a touchdown display 740. Touchdown display 740 indicates a payout factor for a wager that the individual player will score a touchdown. For example, if the individual player scores a touchdown, a wager will pay 25 times the amount wagered. Graphical user interface 700 also comprises a pick amount field and potential score display 745 associated with touchdown display 740. The functions and operations of pick amount field and potential score display 745 are similar to pick amount field 512 and potential score display 518 of FIG. 5. For example, pick amount field and potential score display 745 displays and enables a selection of a wager amount on a touchdown, and a display of a potential score, factoring in a payout factor, should the individual player score a touchdown.

Graphical user interface 700 comprises a fumble display 750. Fumble display 750 indicates a payout factor for a wager that the individual player will fumble. For example, if the individual player fumbles, a wager will pay 20 times the amount wagered. Graphical user interface 700 also comprises a pick amount field and potential score display 755 associated with fumble display 750. The functions and operations of pick amount field and potential score display 755 are similar to pick amount field 512 and potential score display 518 of FIG. 5. For example, pick amount field and potential score display 755 displays and enables a selection of a wager amount on a fumble, and a display of a potential score, factoring in a payout factor, should the individual player fumble.

In accordance with embodiments of the present invention, the amounts displayed in a pick amount field and a potential score display may be in a real currency, e.g., Chinese Renminbi (“ [symbol] ”), or in a virtual currency, e.g., social or fantasy points, or “chips.”

Graphical user interface 700 further comprises a cancel button 771, a submit button 772 and a “bet amount” field 780. Bet amount field 780 displays the total amount, e.g., in points, a user will bet, e.g., be at risk, if the bet is placed. Touching or otherwise indicating cancel button 771 terminates the current creation of a bet. Touching or otherwise indicating submit button 772 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

The position of display elements and fields within graphical user interface 700 may vary according to a primary function of a selected player, in accordance with embodiments of the present invention. In the example of FIG. 7, the player selected is a wide receiver whose primary function is to catch passes. Accordingly, catch display 720 and its associated display and entry elements 725 may be located above run display 730 and its associated display and entry elements 735. If a running back had been selected, the order of catch display 720 and run display 730 may be reversed, in some embodiments.

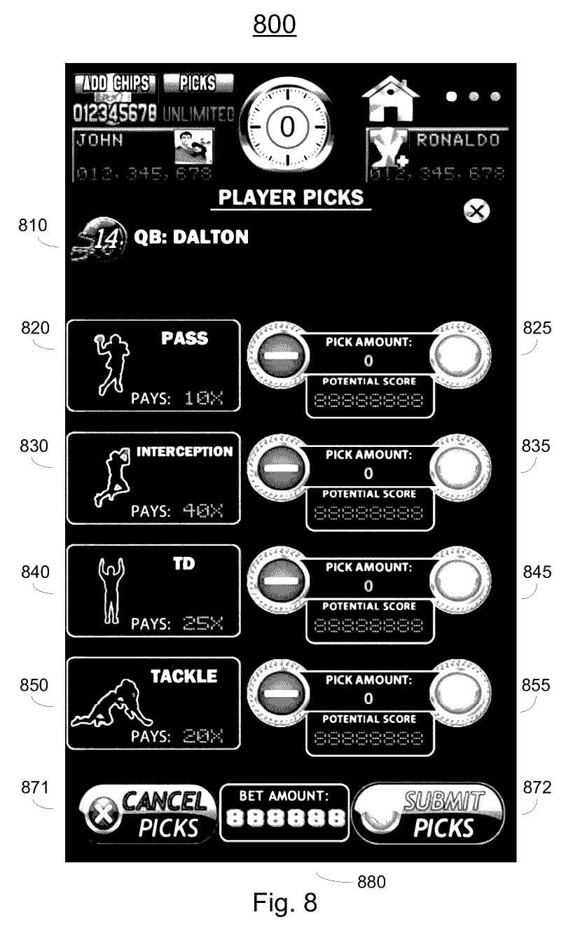

FIG. 8 illustrates an exemplary graphical user interface (GUI) 800 for quarterback wagering, in accordance with embodiments of the present invention. Graphical user interface 800 for quarterback wagering may be displayed, for example, in response to a user touching a quarterback's player icon, e.g., player group icon 210 of FIG. 2. Display 810 of graphical user interface 800 indicates a quarterback, e.g., number 14, selected for the position on a micro event. Graphical user interface 800 comprises a pass display 820. Pass display 820 indicates a payout factor for a wager that the quarterback, e.g., player number 14, will complete a pass. For example, if the quarterback completes a pass, a wager will pay 10 times the amount wagered. Graphical user interface 800 also comprises a pick amount field and potential score display 825 associated with pass display 820. The functions and operations of pick amount field and potential score display 825 are similar to pick amount field 512 and potential score display 518 of FIG. 5. For example, pick amount field and potential score display 825 displays and enables a selection of a wager amount on a completion, and a display of a potential score, factoring in a payout factor, should the quarterback complete a pass.

Graphical user interface 800 comprises an interception display 830. Interception display 830 indicates a payout factor for a wager that the quarterback will throw an interception. For example, if the quarterback throws an interception, a wager will pay 40 times the amount wagered. Graphical user interface 800 also comprises a pick amount field and potential score display 835 associated with interception display 830. The functions and operations of pick amount field and potential score display 835 are similar to pick amount field 512 and potential score display 518 of FIG. 5. For example, pick amount field and potential score display 835 displays and enables a selection of a wager amount on an interception, and a display of a potential score, factoring in a payout factor, should the quarterback throw an interception.

Graphical user interface 800 comprises a touchdown display 840. Touchdown display 840 indicates a payout factor for a wager that the quarterback will score a touchdown. For example, if the quarterback scores a touchdown, e.g., running or passing, a wager will pay 25 times the amount wagered. Graphical user interface 800 also comprises a pick amount field and potential score display 845 associated with touchdown display 840. The functions and operations of pick amount field and potential score display 845 are similar to pick amount field 512 and potential score display 518 of FIG. 5. For example, pick amount field and potential score display 845 displays and enables a selection of a wager amount on a touchdown, and a display of a potential score, factoring in a payout factor, should the quarterback score a touchdown.

Graphical user interface 800 comprises a tackle display 850. Tackle display 850 indicates a payout factor for a wager that the quarterback will be tackled, either while running the ball or attempting to pass, e.g., a sack. For example, if the quarterback is tackled, a wager will pay 20 times the amount wagered. Graphical user interface 800 also comprises a pick amount field and potential score display 855 associated with tackle display 850. The functions and operations of pick amount field and potential score display 855 are similar to pick amount field 512 and potential score display 518 of FIG. 5. For example, pick amount field and potential score display 855 displays and enables a selection of a wager amount on a quarterback tackle, and a display of a potential score, factoring in a payout factor, should the quarterback be tackled.

In accordance with embodiments of the present invention, the amounts displayed in a pick amount field and a potential score display may be in a real currency, e.g., Hong Kong Dollars (“HK$”), or in a virtual currency, e.g., social or fantasy points, or “chips.”

Graphical user interface 800 further comprises a cancel button 871, a submit button 872 and a “bet amount” field 880. Bet amount field 880 displays the total amount, e.g., in points, a user will bet, e.g., be at risk, if the bet is placed. Touching or otherwise indicating cancel button 871 terminates the current creation of a bet. Touching or otherwise indicating submit button 872 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

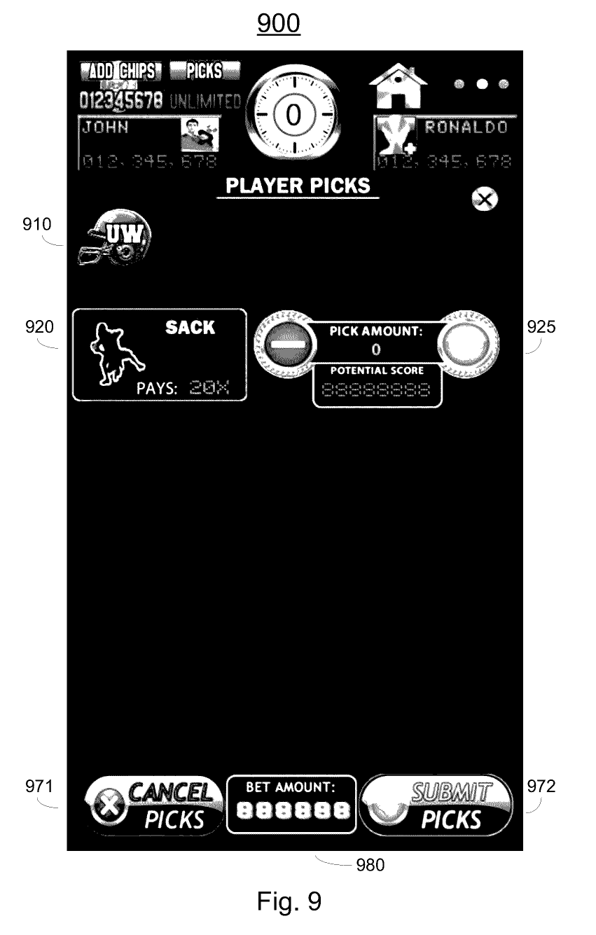

FIG. 9 illustrates an exemplary graphical user interface (GUI) 900 for team sack wagering, in accordance with embodiments of the present invention. Graphical user interface 900 for team sack wagering may be displayed, for example, in response to a user touching a team sack icon, e.g., team sack icon 266 of FIG. 2. Display 910 of graphical user interface 900 indicates a team, e.g., a defensive team, selected for the position on a micro event. Graphical user interface 900 comprises a sack display 920. Sack display 920 indicates a payout factor for a wager that the defensive team will tackle a player attempting a pass behind the line of scrimmage. For example, if the team sacks the opposing quarterback, a wager will pay 20 times the amount wagered. Graphical user interface 900 also comprises a pick amount field and potential score display 925 associated with sack display 920. The functions and operations of pick amount field and potential score display 925 are similar to pick amount field 512 and potential score display 518 of FIG. 5. For example, pick amount field and potential score display 925 displays and enables a selection of a wager amount on a sack, and a display of a potential score, factoring in a payout factor, should a sack happen.

Graphical user interface 900 further comprises a cancel button 971, a submit button 972 and a “bet amount” field 980. Bet amount field 980 displays the total amount, e.g., in points, a user will bet, e.g., be at risk, if the bet is placed. Touching or otherwise indicating cancel button 971 terminates the current creation of a bet. Touching or otherwise indicating submit button 972 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

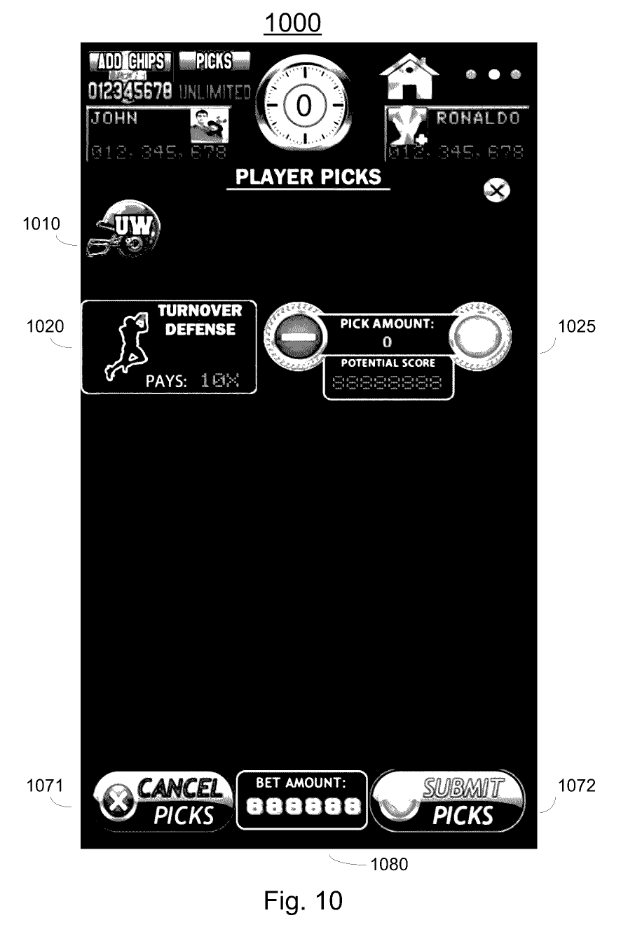

FIG. 10 illustrates an exemplary graphical user interface (GUI) 1000 for team turnover wagering, in accordance with embodiments of the present invention. Graphical user interface 1000 for team turnover wagering may be displayed, for example, in response to a user touching a team turnover icon, e.g., team turnover icon 264 of FIG. 2. Display 1010 of graphical user interface 1000 indicates a team, e.g., a defensive team, selected for the position on a micro event. Graphical user interface 1000 comprises a turnover display 1020. Turnover display 1020 indicates a payout factor for a wager that the defensive team will recover a fumble or interception. For example, if the team recovers a turnover, a wager will pay 10 times the amount wagered. Graphical user interface 1000 also comprises a pick amount field and potential score display 1025 associated with turnover display 1020. The functions and operations of pick amount field and potential score display 1025 are similar to pick amount field 512 and potential score display 518 of FIG. 5. For example, pick amount field and potential score display 1025 displays and enables a selection of a wager amount on a turnover, and a display of a potential score, factoring in a payout factor, should a turnover occur.

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 1000 further comprises a cancel button 1071, a submit button 1072 and a “bet amount” field 1080. Bet amount field 1080 displays the total amount, e.g., in points, a user will bet, e.g., be at risk, if the bet is placed. Touching or otherwise indicating cancel button 1071 terminates the current creation of a bet. Touching or otherwise indicating submit button 1072 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

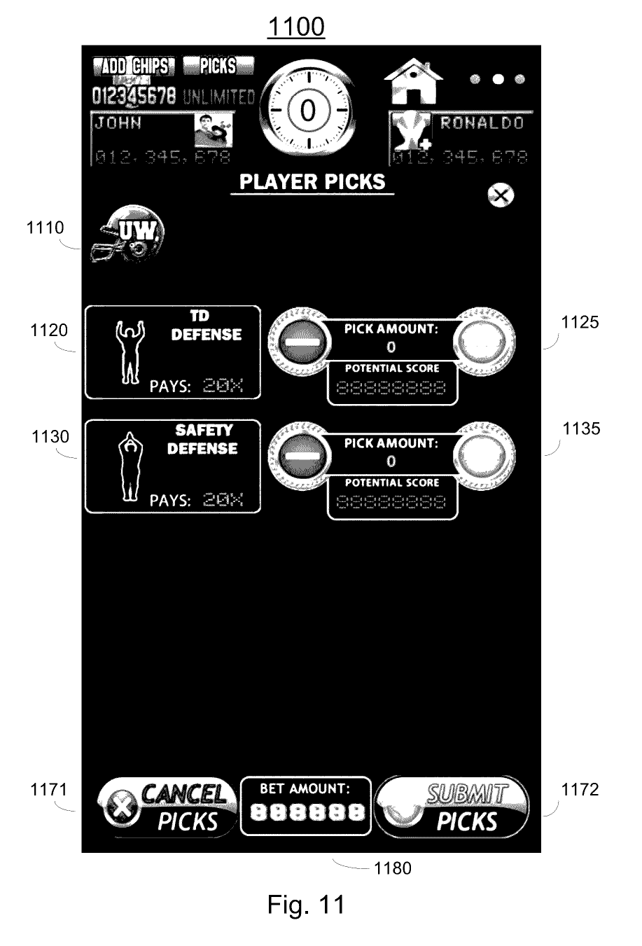

FIG. 11 illustrates an exemplary graphical user interface (GUI) 1100 for defensive score wagering, in accordance with embodiments of the present invention. Graphical user interface 1100 for defensive score wagering may be displayed, for example, in response to a user touching a defensive score icon, e.g., team touchdown/safety icon 268 of FIG. 2. Display 1110 of graphical user interface 1100 indicates a team, e.g., a defensive team, selected for the position on a micro event. Graphical user interface 1100 comprises a defensive touchdown display 1120. Defensive touchdown display 1120 indicates a payout factor for a wager that the defensive team will score a touchdown. For example, if the defensive team scores a touchdown, a wager will pay 10 times the amount wagered. Graphical user interface 1100 also comprises a pick amount field and potential score display 1125 associated with defensive touchdown display 1120. The functions and operations of pick amount field and potential score display 1125 are similar to pick amount field 512 and potential score display 518 of FIG. 5. For example, pick amount field and potential score display 1125 displays and enables a selection of a wager amount on a defensive touchdown, and a display of a potential score, factoring in a payout factor, should a the defense score a touchdown.

Graphical user interface 1100 also comprises a safety display 1130. Safety display 1130 indicates a payout factor for a wager that the defensive team will score a safety, e.g., tackle a ball carrier in the end zone behind the offense. For example, if the defensive team scores a safety, a wager will pay 20 times the amount wagered. Graphical user interface 1100 also comprises a pick amount field and potential score display 1135 associated with safety display 1130. The functions and operations of pick amount field and potential score display 1135 are similar to pick amount field 512 and potential score display 518 of FIG. 5. For example, pick amount field and potential score display 1135 displays and enables a selection of a wager amount on a safety, and a display of a potential score, factoring in a payout factor, should a the defense score a safety.

In accordance with embodiments of the present invention, the amounts displayed in a pick amount field and a potential score display may be in a real currency, e.g., Thai baht (“THB”), or in a virtual currency, e.g., social or fantasy points, or “chips.”

Graphical user interface 1100 further comprises a cancel button 1171, a submit button 1172 and a “bet amount” field 1180. Bet amount field 1180 displays the total amount, e.g., in points, a user will bet, e.g., be at risk, if the bet is placed. Touching or otherwise indicating cancel button 1171 terminates the current creation of a bet. Touching or otherwise indicating submit button 1172 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

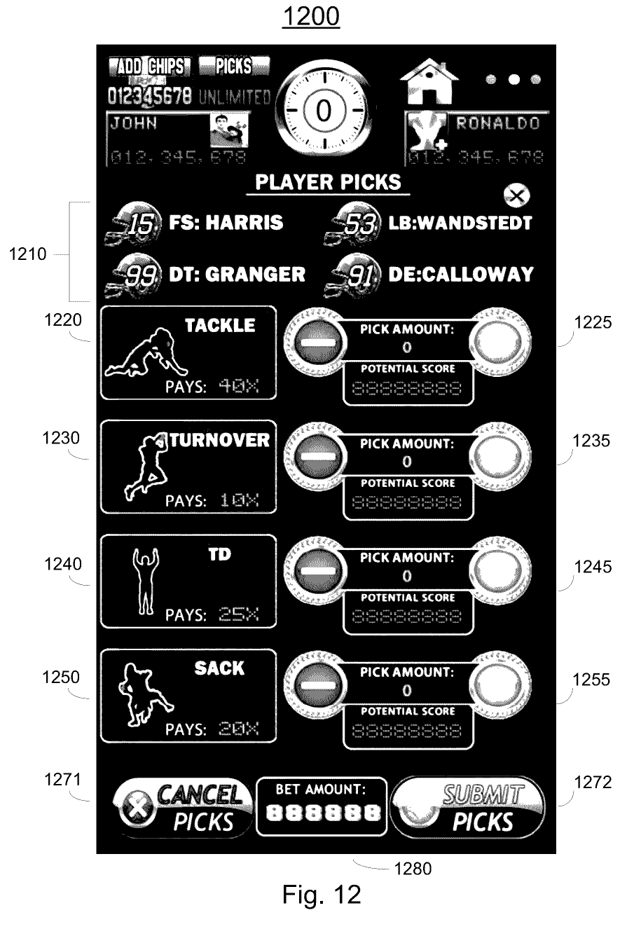

FIG. 12 illustrates an exemplary graphical user interface (GUI) 1200 for defensive player group wagering, in accordance with embodiments of the present invention. Graphical user interface 1200 for defensive player group wagering may be displayed, for example, in response to a user touching a defensive player group icon, e.g., player group icon 221 of FIG. 2. For example, a player group icon amongst players 15, 53, 99, and 91 was selected. Display 1210 of graphical user interface 1200 indicates the four players selected for the position on a micro event. Graphical user interface 1200 comprises a tackle display 1220. Tackle display 1220 indicates a payout factor for a wager that one or more of the particular group of players, e.g., players 15, 53, 99, and/or 91, will be involved in tackling a ball carrier. For example, if one of the four players tackles a ball carrier, a wager will pay 40 times the amount wagered. Graphical user interface 1200 also comprises a pick amount field and potential score display 1225 associated with tackle display 1220. The functions and operations of pick amount field and potential score display 1225 are similar to pick amount field 512 and potential score display 518 of FIG. 5. For example, pick amount field and potential score display 1225 displays and enables a selection of a wager amount on a tackle, and a display of a potential score, factoring in a payout factor, should one of the four specific players make a tackle.

Graphical user interface 1200 comprises a turnover display 1230. Turnover display 1220 indicates a payout factor for a wager that one or more of the particular group of players, e.g., players 15, 53, 99, and/or 91, will recover a turnover, e.g., a fumble or interception. For example, if one of the four players recovers a turnover, a wager will pay 10 times the amount wagered. Graphical user interface 1200 also comprises a pick amount field and potential score display 1235 associated with turnover display 1220. The functions and operations of pick amount field and potential score display 1235 are similar to pick amount field 512 and potential score display 518 of FIG. 5. For example, pick amount field and potential score display 1235 displays and enables a selection of a wager amount on a turnover, and a display of a potential score, factoring in a payout factor, should one of the four specific players recover a turnover.

Graphical user interface 1200 also comprises a touchdown display 1240. Touchdown display 1240 indicates a payout factor for a wager that one or more of the particular group of players, e.g., players 15, 53, 99, and/or 91, will score a touchdown, e.g., by returning a turnover. For example, if one of the four players scores a touchdown, a wager will pay 25 times the amount wagered. Graphical user interface 1200 also comprises a pick amount field and potential score display 1245 associated with run display 1240. The functions and operations of pick amount field and potential score display 1245 are similar to pick amount field 512 and potential score display 518 of FIG. 5. For example, pick amount field and potential score display 1245 displays and enables a selection of a wager amount on a defensive touchdown, and a display of a potential score, factoring in a payout factor, should one of the four specific players score a touchdown.

Graphical user interface 1200 comprises a sack display 1250. Sack display 1250 indicates a payout factor for a wager that one or more of the particular group of players, e.g., players 15, 53, 99, and/or 91, will tackle an offensive player attempting a pass behind the line of scrimmage. For example, if one of the four players sacks a quarterback, a wager will pay 20 times the amount wagered. Graphical user interface 1200 also comprises a pick amount field and potential score display 1255 associated with sack display 1250. The functions and operations of pick amount field and potential score display 1255 are similar to pick amount field 512 and potential score display 518 of FIG. 5. For example, pick amount field and potential score display 1255 displays and enables a selection of a wager amount on a sack, and a display of a potential score, factoring in a payout factor, should one of the four specific players record a sack.

In accordance with embodiments of the present invention, the amounts displayed in a pick amount field and a potential score display may be in a real currency, e.g., Indian rupees (“INR”), or in a virtual currency, e.g., social or fantasy points, or “chips.”

Graphical user interface 1200 further comprises a cancel button 1271, a submit button 1272 and a “bet amount” field 1280. Bet amount field 1280 displays the total amount, e.g., in points, a user will bet, e.g., be at risk, if the bet is placed. Touching or otherwise indicating cancel button 1271 terminates the current creation of a bet. Touching or otherwise indicating submit button 1272 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

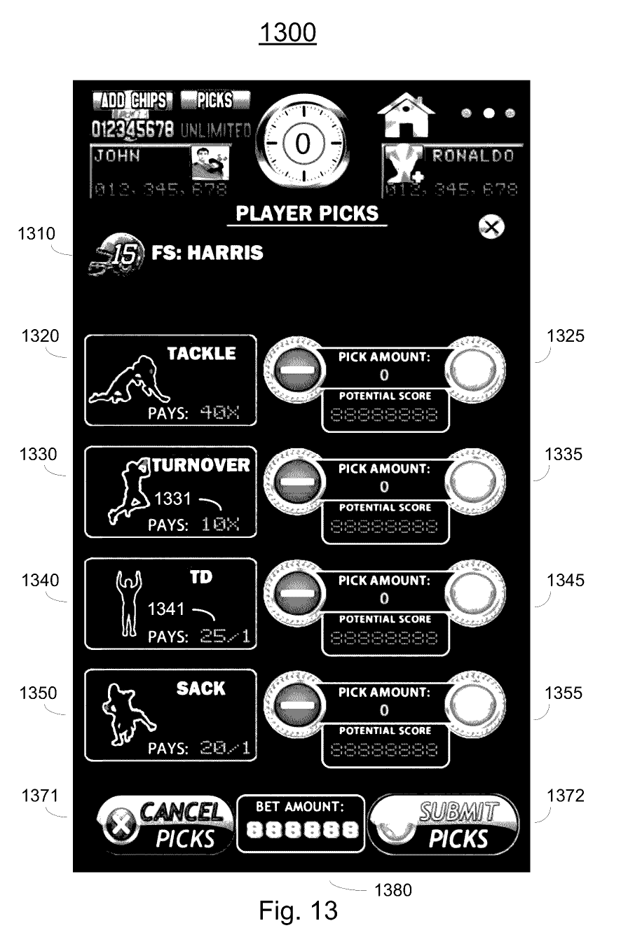

FIG. 13 illustrates an exemplary graphical user interface (GUI) 1300 for individual defensive player wagering, in accordance with embodiments of the present invention. Graphical user interface 1300 for individual defensive player wagering may be displayed, for example, in response to a user touching a player icon, e.g., player group icon 211 of FIG. 2. Graphical user interface 130 for individual defensive player wagering may also be displayed, for example, in response to a user touching a “wild card” player icon, e.g., an icon for defensive player “00.” In such a case, the subsequent described items refer to any player whose number is not displayed on graphical user interface 200 of FIG. 2. Display 1310 of graphical user interface 1300 indicates an individual defensive player, e.g., player number 15, selected for the position on a micro event. Graphical user interface 1300 comprises a tackle display 1320. Tackle display 1320 indicates a payout factor for a wager that the individual player, e.g., player number 15, will be involved in a tackle. For example, if the individual player tackles a ball carrier, a wager will pay 40 times the amount wagered. Graphical user interface 1300 also comprises a pick amount field and potential score display 1325 associated with tackle display 1320. The functions and operations of pick amount field and potential score display 1325 are similar to pick amount field 512 and potential score display 518 of FIG. 5. For example, pick amount field and potential score display 1325 displays and enables a selection of a wager amount on a tackle, and a display of a potential score, factoring in a payout factor, should the individual player make a tackle.

Graphical user interface 1300 comprises a turnover display 1330. Turnover display 1330 indicates a payout factor 1331 for a wager that the individual player recover a turnover, e.g., a fumble or an interception. For example, if the individual player recovers a turnover, a wager will pay 10 times the amount wagered. Graphical user interface 1300 also comprises a pick amount field and potential score display 1335 associated with turnover display 1330. The functions and operations of pick amount field and potential score display 1335 are similar to pick amount field 512 and potential score display 518 of FIG. 5. For example, pick amount field and potential score display 1335 displays and enables a selection of a wager amount on a turnover, and a display of a potential score, factoring in a payout factor, should the individual player recovers a turnover.

Graphical user interface 1300 comprises a touchdown display 1340. Touchdown display 1340 indicates a payout factor 1341 for a wager that the individual player will score a touchdown. For example, if the individual player scores a touchdown, a wager will pay 25 times the amount wagered. Graphical user interface 1300 also comprises a pick amount field and potential score display 1345 associated with touchdown display 1340. It is appreciated that payout factor 1341 is presented as a fraction, in a common “odds” format, e.g., “25 to 1.” An “odds format,” e.g., as presented for payout factor 1341, may be used for real money wagers in some embodiments. A multiplication factor presentation of a payout factor, e.g., “10×,” as presented in payout factor 1331, may be used for a variety of virtual currency wagering, in accordance with some embodiments.

The functions and operations of pick amount field and potential score display 1345 are similar to pick amount field 512 and potential score display 518 of FIG. 5. For example, pick amount field and potential score display 1345 displays and enables a selection of a wager amount on a touchdown, and a display of a potential score, factoring in a payout factor, should the individual player score a touchdown.

Graphical user interface 1300 comprises a sack display 1350. Sack display 1350 indicates a payout factor for a wager that the individual player will tackle an offensive player attempting to pass behind the line of scrimmage. For example, if the individual player sacks a quarterback, a wager will pay 20 times the amount wagered. Graphical user interface 1300 also comprises a pick amount field and potential score display 1355 associated with sack display 1350. The functions and operations of pick amount field and potential score display 1355 are similar to pick amount field 512 and potential score display 518 of FIG. 5. For example, pick amount field and potential score display 1355 displays and enables a selection of a wager amount on a sack, and a display of a potential score, factoring in a payout factor, should the individual player sack an opposing player.

In accordance with embodiments of the present invention, the amounts displayed in a pick amount field and a potential score display may be in a real currency, e.g., Chinese Renminbi (“ [symbol] ”), or in a virtual currency, e.g., social or fantasy points, or “chips.”

Graphical user interface 1300 further comprises a cancel button 1371, a submit button 1372 and a “bet amount” field 1380. Bet amount field 1380 displays the total amount, e.g., in points, a user will bet, e.g., be at risk, if the bet is placed. Touching or otherwise indicating cancel button 1371 terminates the current creation of a bet. Touching or otherwise indicating submit button 1372 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

The position of display elements and fields within graphical user interface 1300 may vary according to a primary function of a selected player, in accordance with embodiments of the present invention. In the example of FIG. 13, the player selected is a free safety, whose primary function is to defend passes down field. Accordingly, sack display 1350 and its associated display and entry elements 1355 may be located below tackle display 1320 and its associated display and entry elements 1325, as a free safety may generally be unlikely to record a sack. If a player in a different defensive position, e.g., a lineman, had been selected, the order of some of the displays 1320, 1330, 1340, and/or 1350 may be changed, in some embodiments.

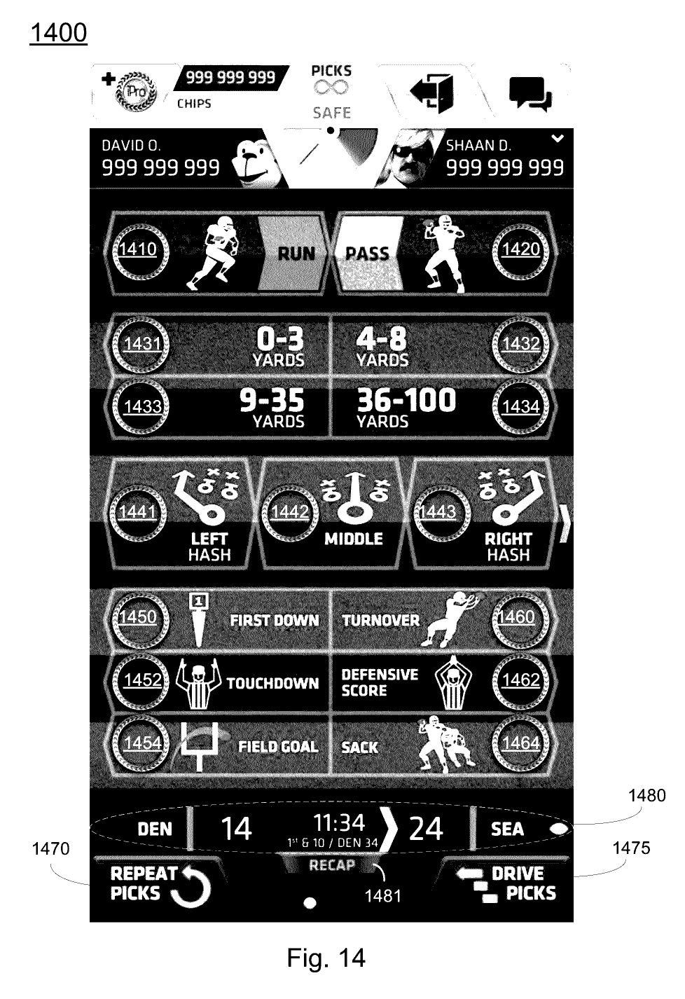

FIG. 14 illustrates an exemplary graphical user interface (GUI) 1400 for selecting team results of a micro event, in accordance with embodiments of the present invention. Graphical user interface 1400 may be presented, for example, responsive to a “swipe” action at graphical user interface 200 of FIG. 2. Graphical user interface 1400 enables a user to specify a prediction of the results of a next play, e.g., a next micro event, at a team level. A user may predict a running play, e.g., that any player will run with the ball, via run icon 1410, or may predict a passing play, e.g., that any player will legally catch a pass, via pass icon 1420. A user may predict how many yards a play will gain, e.g., via 0-3 yards icon 1431, 4-8 yards icon 1432, 8-36 yards icon 1433 and 36-100 yards icon 1434. A user may also predict a direction of an upcoming play, e.g., left hash icon 1441, middle icon 1442, or right hash icon 1443.

Some legal jurisdictions do not allow real money fantasy wagers on a team basis. For example, such wagers must involve a specific player. In some embodiments, run icon 1410 and pass icon 1420 may be understood to be a handoff by the quarterback or a pass by the quarterback, respectively. The yardage gained icons, e.g., icons 1431, 1432, 1433, and/or 1444, are only available for selection subsequent to a selection of run or pass, by the quarterback. Similarly, the play direction icons, e.g., icons 1441, 1442, and/or 1443, are only available for selection subsequent to a selection of run or pass, by the quarterback. In this manner, all wagers are tied to a specific player, e.g., the quarterback. If a user selects a yardage gained icon or a play direction icon prior to selecting run icon 1410 or pass icon 1420, a pop-up message will be displayed to the effect of: “This bet is not available unless you have already bet RUN or PASS.”

Alternatively, in some embodiments, a user may select a specific player as further described in co-pending, commonly owned U.S. patent application Ser. No. ______, attorney docket IPRO-0004-01.01US, filed Apr. 10, 2015, entitled “System and Method for On-line Fantasy Wagering” to Ortiz et al., which is incorporated by reference herein in its entirety.

Graphical user interface 1400 also comprises a “repeat picks” icon 1470 for creating the same position on a subsequent micro event as was taken on an immediately preceding micro event. For example, if a user predicted a run up the left hash for 0-3 yards for the last play, touching the “repeat picks” icon 1470 will establish a position of a run up the left hash for 0-3 yards for the next play. Graphical user interface 1400 comprises a scoreboard display 1480 presenting a variety of information on the status of a sporting contest, including, for example, game score, which team has the ball, time remaining, quarter, down, position on the field, yards to go, and the like. Graphical user interface 1400 further comprises a “drive picks” icon 1475. Touching drive picks icon 1475 initiates a different version of a graphical user interface for use when a duration between plays is decreased, for example, when a multi-player interactive player might not have enough time to select details of a micro event according to graphical user interface 200 or graphical user interface 1400, e.g., when the offense is playing a “no huddle” style of play or when a user desires to make the same or similar picks for the duration of a “drive.” In general, the picks made within a drive picks graphical user interface(s) will last until the ball changes possession. In general, a user will be able to initiate a “drive picks” mode of game play during fourth down, punt return and/or kick-off return scenarios. In some embodiments, a user may be limited to initiation of drive picks to only such scenarios.

Graphical user interface 1400 comprises a group of “game event” icons 1450, 1452, 1454, 1560, 1462 and 1464. Game event icons 1450, 1452 and 1454 are generally associated with offensive team achievements, while game event icons 1560, 1462 and 1464 are generally associated with defensive team achievements. Game event icons are used to predict offensive and/or defensive team achievements, in accordance with embodiments of the present invention. Game event icons are not exclusive of the other icons 1410 through 1443. For example, in an first scenario, a user may select only game event first down icon 1450, indicating a prediction that the offense will achieve a first down, by any means. In a second scenario, a user may select game event first down icon 1450 and run icon 1410, indicating a prediction that the offense will achieve a first down by running the ball. The latter prediction comprising a run for a first down is more specific that the former prediction of a first down by any means, and may have a greater likelihood factor, or odds, and a potentially larger payout for an equivalent wager. All such combinations that are consistent with the rules and structure of the current sporting event may be allowed. Some combinations, e.g., an offensive first down 1450 coupled with a defensive sack 1464 may not be allowed.

Game event first down icon 1450 is used to enter a user prediction that a next play, e.g., a micro event, will result in a first down for the offense. Game event touch down icon 1452 is used to enter a user prediction that a next play, e.g., a micro event, will result in a touch down for the offense. Game event field goal icon 1454 is used to enter a user prediction that a next play, e.g., a micro event, will result in a field goal for the offense.

Game event turnover icon 1460 is used to enter a user prediction that a next play, e.g., a micro event, will result in a turnover for the defense, e.g., the offense looses the ball. Game event defensive score icon 1462 is used to enter a user prediction that a next play, e.g., a micro event, will result in a score, e.g., a safety or a touchdown, for the defense. Game event sack icon 1464 is used to enter a user prediction that a next play, e.g., a micro event, will result in a sack for the defense.

Further, graphical user interface 1400 comprises a recap button 1481. Selection, e.g., by touching, of recap button 1481 initiates a display of details of past plays and/or past wagers.

In accordance with embodiments of the present invention, multiple wager selections of graphical user interface may be made independently of each other, in any number and/or combination. For example, a user may select both run icon 1410 and pass icon 1420 to wager on both outcomes of a micro event. Similarly, a user may select all three or no play direction icons.

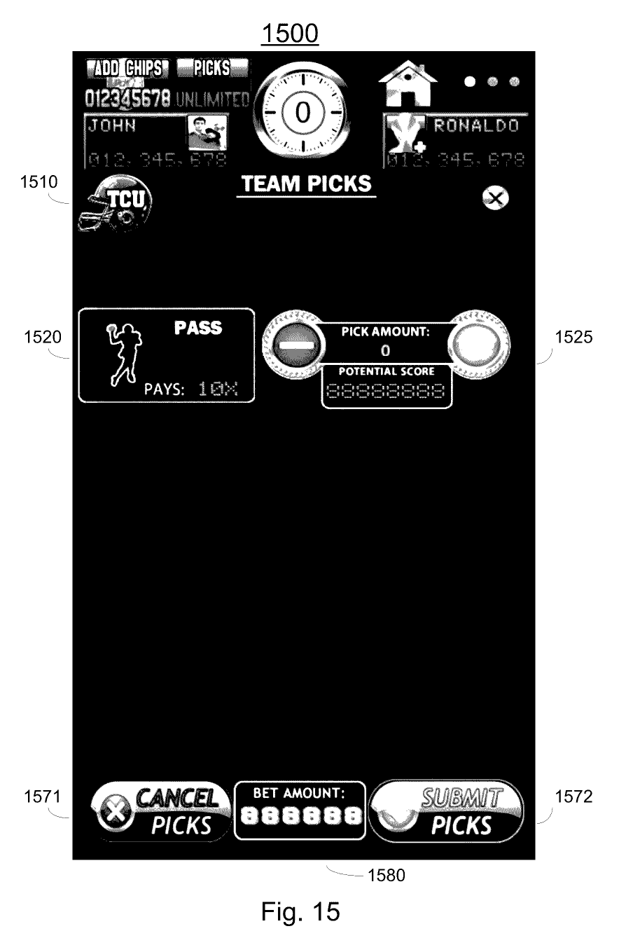

FIG. 15 illustrates an exemplary graphical user interface (GUI) 1500 for team pass wagering, in accordance with embodiments of the present invention. Graphical user interface 1500 for team pass wagering may be displayed, for example, in response to a user touching a team pass icon, e.g., team pass icon 1420 of FIG. 14. Display 1510 of graphical user interface 1500 indicates a team, e.g., an offensive team, selected for the position on a micro event. Graphical user interface 1500 comprises a pass display 1520. Pass display 1520 indicates a payout factor for a wager that the offensive team will complete a pass. For example, if the team completes a pass, a wager will pay 10 times the amount wagered. Graphical user interface 1500 also comprises a pick amount field and potential score display 1525 associated with pass display 1520. The functions and operations of pick amount field and potential score display 1525 are similar to pick amount field 512 and potential score display 518 of FIG. 5. For example, pick amount field and potential score display 1525 displays and enables a selection of a wager amount on a pass, and a display of a potential score, factoring in a payout factor, should a pass be completed.

If the wagering game is real money fantasy wagering, a quarterback's player number will be displayed on display 1510 of graphical user interface 1500, along with text generally of the form, “Player number ### completes a pass.”

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 1500 further comprises a cancel button 1571, a submit button 1572 and a “bet amount” field 1580. Bet amount field 1580 displays the total amount, e.g., in points, a user will bet, e.g., be at risk, if the bet is placed. Touching or otherwise indicating cancel button 1571 terminates the current creation of a bet. Touching or otherwise indicating submit button 1572 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

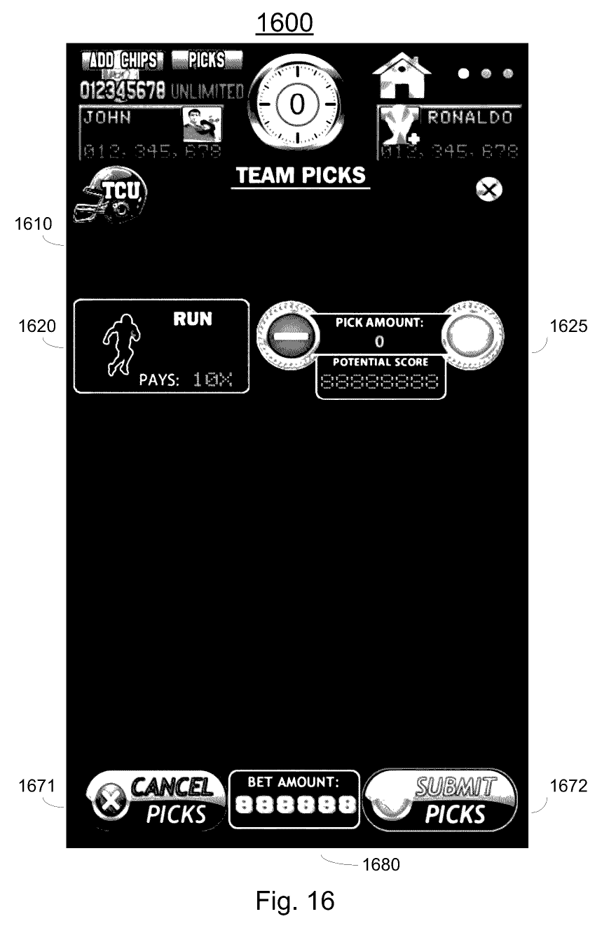

FIG. 16 illustrates an exemplary graphical user interface (GUI) 1600 for team run wagering, in accordance with embodiments of the present invention. Graphical user interface 1600 for team run wagering may be displayed, for example, in response to a user touching a team run icon, e.g., team run icon 1410 of FIG. 14. Display 1610 of graphical user interface 1600 indicates a team, e.g., an offensive team, selected for the position on a micro event. Graphical user interface 1600 comprises a run display 1620. Run display 1620 indicates a payout factor for a wager that the offensive team will run the ball. For example, if the team runs the ball, a wager will pay 10 times the amount wagered. Graphical user interface 1600 also comprises a pick amount field and potential score display 1625 associated with run display 1620. The functions and operations of pick amount field and potential score display 1625 are similar to pick amount field 512 and potential score display 518 of FIG. 5. For example, pick amount field and potential score display 1625 displays and enables a selection of a wager amount on a run, and a display of a potential score, factoring in a payout factor, should the team run a running play.

If the wagering game is real money fantasy wagering, a quarterback's player number will be displayed on display 1610 of graphical user interface 1600, along with text generally of the form, “Player number ### hands off.”

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 1600 further comprises a cancel button 1671, a submit button 1672 and a “bet amount” field 1680. Bet amount field 1680 displays the total amount, e.g., in points, a user will bet, e.g., be at risk, if the bet is placed. Touching or otherwise indicating cancel button 1671 terminates the current creation of a bet. Touching or otherwise indicating submit button 1672 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

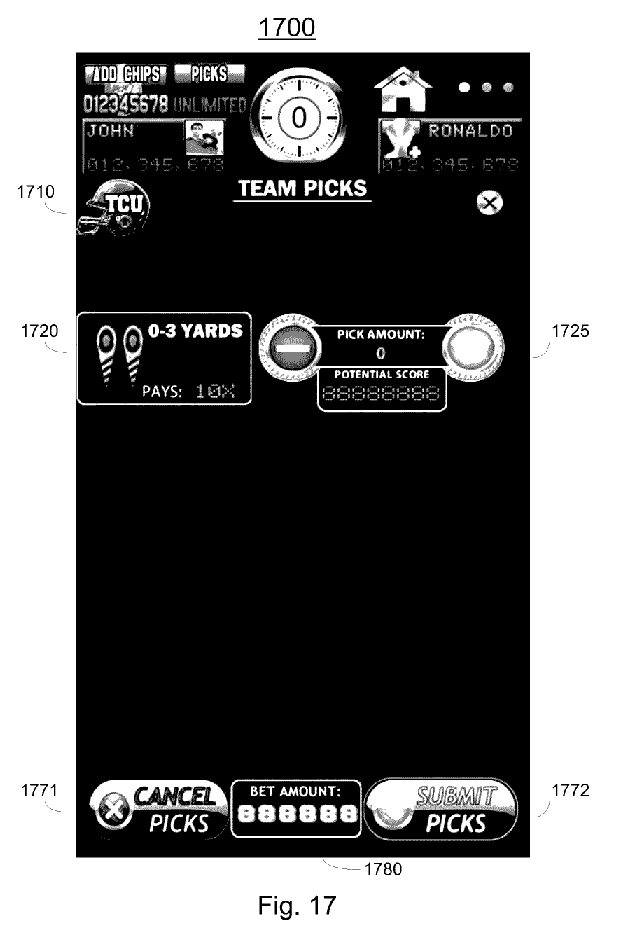

FIG. 17 illustrates an exemplary graphical user interface (GUI) 1700 for team gain 0-3 yards wagering, in accordance with embodiments of the present invention. Graphical user interface 1700 for team gain 0-3 yards wagering may be displayed, for example, in response to a user touching a team gain 0-3 yards icon, e.g., team gain 0-3 yards icon 1431 of FIG. 14. Display 1710 of graphical user interface 1700 indicates a team, e.g., an offensive team, selected for the position on a micro event. Graphical user interface 1700 comprises a team gain 0-3 yards display 1720. Team gain display 1720 indicates a payout factor for a wager that the offensive team will gain zero to three yards. For example, if the team gains between zero and three yards, a wager will pay 10 times the amount wagered. Graphical user interface 1700 also comprises a pick amount field and potential score display 1725 associated with team gain 0-3 yards display 1720. The functions and operations of pick amount field and potential score display 1725 are similar to pick amount field 512 and potential score display 518 of FIG. 5. For example, pick amount field and potential score display 1725 displays and enables a selection of a wager amount on a gain of zero to three yards, and a display of a potential score, factoring in a payout factor, should the team gain between zero and three yards.

If the wagering game is real money fantasy wagering, a quarterback's player number will be displayed on display 1710 of graphical user interface 1700, along with text generally of the form, “Player number ### hands off/passes for 0-3 yards.”

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 1700 further comprises a cancel button 1771, a submit button 1772 and a “bet amount” field 1780. Bet amount field 1780 displays the total amount, e.g., in points, a user will bet, e.g., be at risk, if the bet is placed. Touching or otherwise indicating cancel button 1771 terminates the current creation of a bet. Touching or otherwise indicating submit button 1772 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

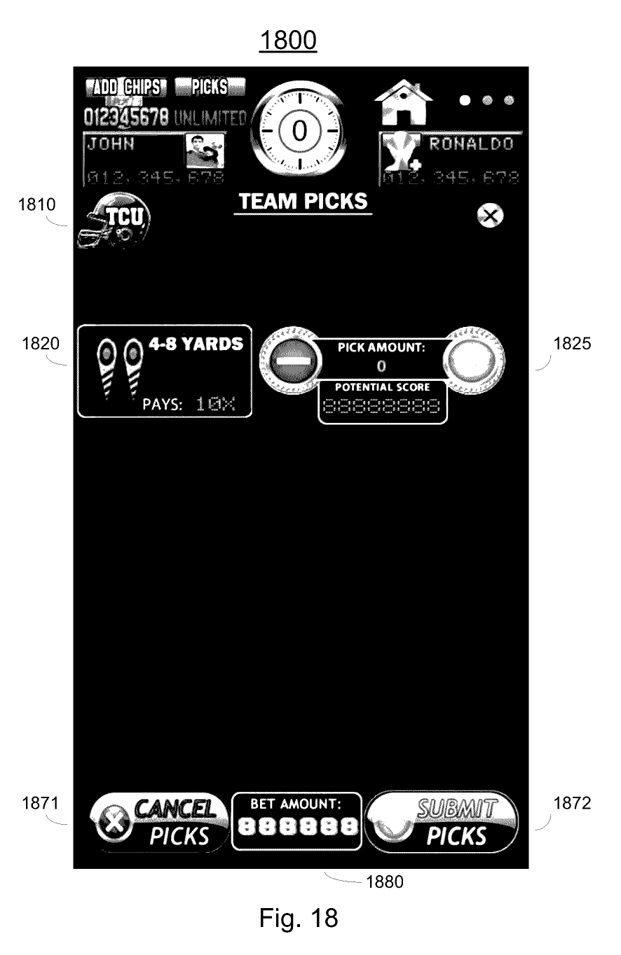

FIG. 18 illustrates an exemplary graphical user interface (GUI) 1800 for team gain 4-8 yards wagering, in accordance with embodiments of the present invention. Graphical user interface 1800 for team gain 4-8 yards wagering may be displayed, for example, in response to a user touching a team gain 4-8 yards icon, e.g., team gain 4-8 yards icon 1432 of FIG. 14. Display 1810 of graphical user interface 1800 indicates a team, e.g., an offensive team, selected for the position on a micro event. Graphical user interface 1800 comprises a team gain 4-8 yards display 1820. Team gain display 1820 indicates a payout factor for a wager that the offensive team will gain four to eight yards. For example, if the team gains between four and eight yards, a wager will pay 10 times the amount wagered. Graphical user interface 1800 also comprises a pick amount field and potential score display 1825 associated with team gain 4-8 yards display 1820. The functions and operations of pick amount field and potential score display 1825 are similar to pick amount field 512 and potential score display 518 of FIG. 5. For example, pick amount field and potential score display 1825 displays and enables a selection of a wager amount on a gain of four to eight yards, and a display of a potential score, factoring in a payout factor, should the team gain between four and eight yards.

If the wagering game is real money fantasy wagering, a quarterback's player number will be displayed on display 1810 of graphical user interface 1800, along with text generally of the form, “Player number ### hands off/passes for 4-8 yards.”

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 1800 further comprises a cancel button 1871, a submit button 1872 and a “bet amount” field 1880. Bet amount field 1880 displays the total amount, e.g., in points, a user will bet, e.g., be at risk, if the bet is placed. Touching or otherwise indicating cancel button 1871 terminates the current creation of a bet. Touching or otherwise indicating submit button 1872 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

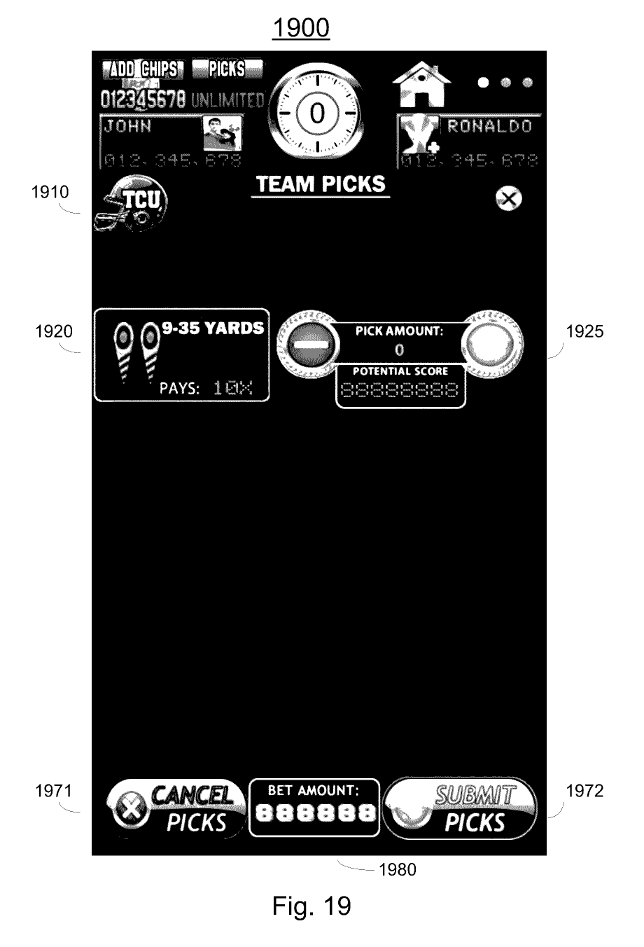

FIG. 19 illustrates an exemplary graphical user interface (GUI) 1900 for team gain 9-35 yards wagering, in accordance with embodiments of the present invention. Graphical user interface 1900 for team gain 9-35 yards wagering may be displayed, for example, in response to a user touching a team gain 9-35 yards icon, e.g., team gain 9-35 yards icon 1433 of FIG. 14. Display 1910 of graphical user interface 1900 indicates a team, e.g., an offensive team, selected for the position on a micro event. Graphical user interface 1900 comprises a team gain 9-35 yards display 1920. Team gain display 1920 indicates a payout factor for a wager that the offensive team will gain nine to thirty-five yards. For example, if the team gains between nine and thirty-five yards, a wager will pay 10 times the amount wagered. Graphical user interface 1900 also comprises a pick amount field and potential score display 1925 associated with team gain 9-35 yards display 1920. The functions and operations of pick amount field and potential score display 1925 are similar to pick amount field 512 and potential score display 518 of FIG. 5. For example, pick amount field and potential score display 1925 displays and enables a selection of a wager amount on a gain of nine to thirty-five yards, and a display of a potential score, factoring in a payout factor, should the team gain between nine and thirty-five yards.

If the wagering game is real money fantasy wagering, a quarterback's player number will be displayed on display 1910 of graphical user interface 1900, along with text generally of the form, “Player number ### hands off/passes for 6-35 yards.”

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 1900 further comprises a cancel button 1971, a submit button 1972 and a “bet amount” field 1980. Bet amount field 1980 displays the total amount, e.g., in points, a user will bet, e.g., be at risk, if the bet is placed. Touching or otherwise indicating cancel button 1971 terminates the current creation of a bet. Touching or otherwise indicating submit button 1972 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

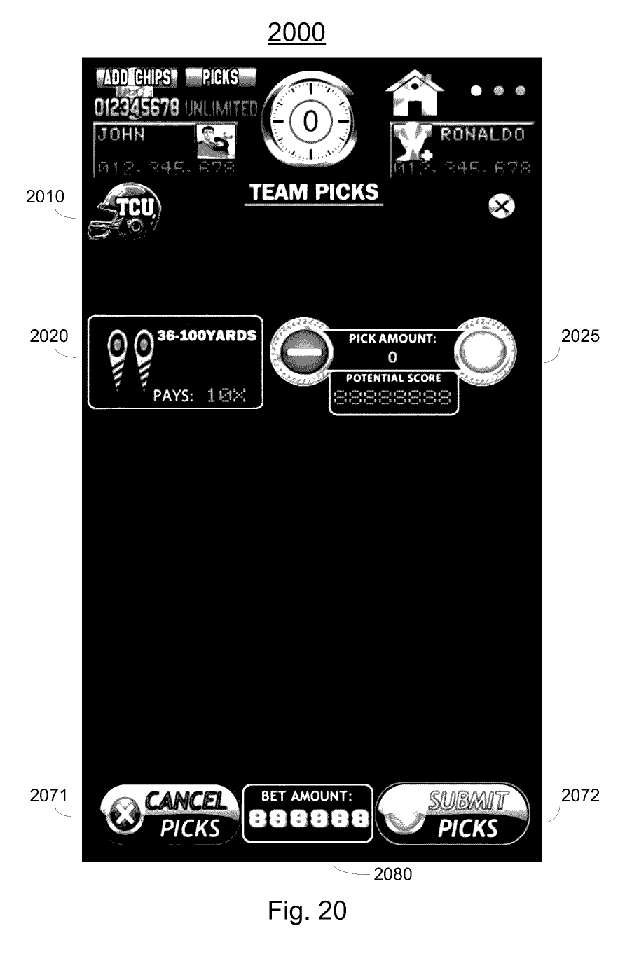

FIG. 20 illustrates an exemplary graphical user interface (GUI) 2000 for team gain 36-100 yards wagering, in accordance with embodiments of the present invention. Graphical user interface 2000 for team gain 36-100 yards wagering may be displayed, for example, in response to a user touching a team gain 36-100 yards icon, e.g., team gain 36-100 yards icon 1434 of FIG. 14. Display 2010 of graphical user interface 2000 indicates a team, e.g., an offensive team, selected for the position on a micro event. Graphical user interface 2000 comprises a team gain 36-100 yards display 2020. Team gain display 2020 indicates a payout factor for a wager that the offensive team will gain thirty-six to one hundred yards. For example, if the team gains between thirty-six and one hundred yards, a wager will pay 10 times the amount wagered. Graphical user interface 2000 also comprises a pick amount field and potential score display 2025 associated with team gain 36-100 yards display 2020. The functions and operations of pick amount field and potential score display 2025 are similar to pick amount field 512 and potential score display 518 of FIG. 5. For example, pick amount field and potential score display 2025 displays and enables a selection of a wager amount on a gain of thirty-six to one hundred yards, and a display of a potential score, factoring in a payout factor, should the team gain between thirty-six and one hundred yards.

If the wagering game is real money fantasy wagering, a quarterback's player number will be displayed on display 2010 of graphical user interface 2000, along with text generally of the form, “Player number ### hands off/passes for 36-100 yards.”

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 2000 further comprises a cancel button 2071, a submit button 2072 and a “bet amount” field 2080. Bet amount field 2080 displays the total amount, e.g., in points, a user will bet, e.g., be at risk, if the bet is placed. Touching or otherwise indicating cancel button 2071 terminates the current creation of a bet. Touching or otherwise indicating submit button 2072 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

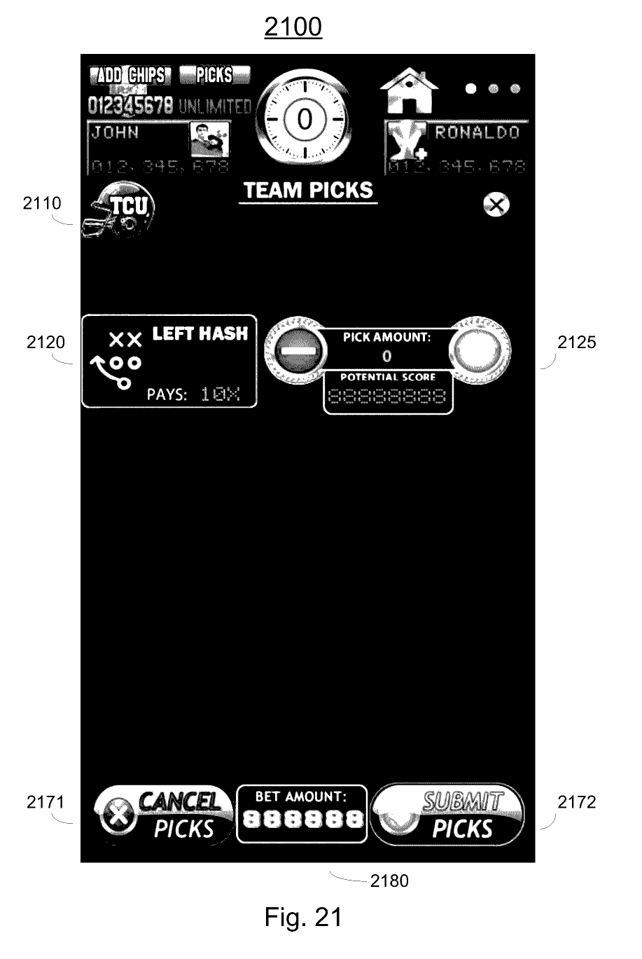

FIG. 21 illustrates an exemplary graphical user interface (GUI) 2100 for team left hash wagering, in accordance with embodiments of the present invention. Graphical user interface 2100 for team left hash wagering may be displayed, for example, in response to a user touching a team left hash icon, e.g., team left hash icon 1441 of FIG. 14. Display 2110 of graphical user interface 2100 indicates a team, e.g., an offensive team, selected for the position on a micro event. Graphical user interface 2100 comprises a team left hash display 2120. Team gain display 2120 indicates a payout factor for a wager that the offensive team will run a play, e.g., a run or a pass, to the offensive left side of the field. For example, if the team runs to the left, a wager will pay 10 times the amount wagered. Graphical user interface 2100 also comprises a pick amount field and potential score display 2125 associated with team left hash display 2120. The functions and operations of pick amount field and potential score display 2125 are similar to pick amount field 512 and potential score display 518 of FIG. 5. For example, pick amount field and potential score display 2125 displays and enables a selection of a wager amount on a play to the left hash, and a display of a potential score, factoring in a payout factor, should the team run a play to the offensive left side of the field

If the wagering game is real money fantasy wagering, a quarterback's player number will be displayed on display 2110 of graphical user interface 2100, along with text generally of the form, “Player number ### hands off/passes to the left.”

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 2100 further comprises a cancel button 2171, a submit button 2172 and a “bet amount” field 2180. Bet amount field 2180 displays the total amount, e.g., in points, a user will bet, e.g., be at risk, if the bet is placed. Touching or otherwise indicating cancel button 2171 terminates the current creation of a bet. Touching or otherwise indicating submit button 2172 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

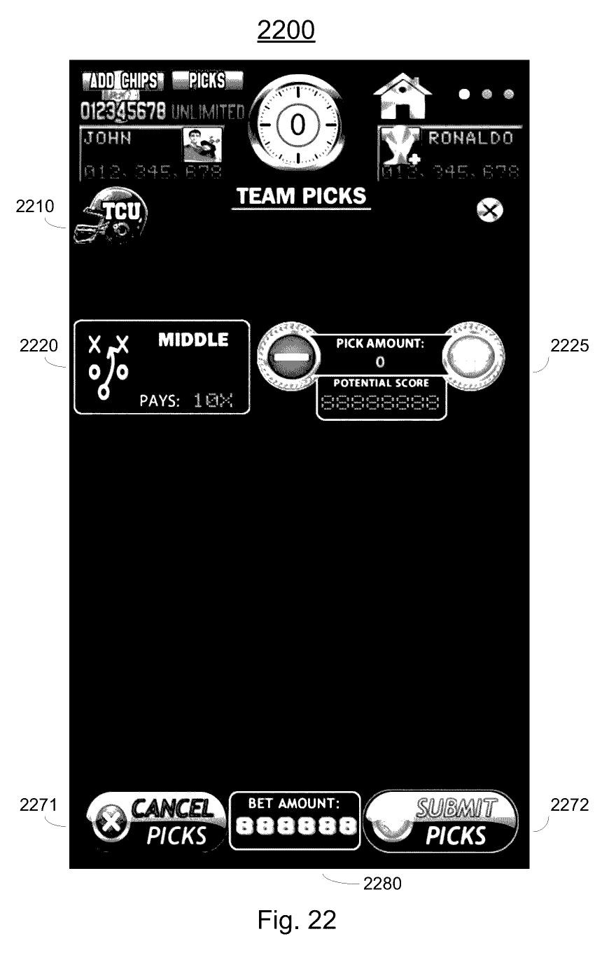

FIG. 22 illustrates an exemplary graphical user interface (GUI) 2200 for team middle of the field wagering, in accordance with embodiments of the present invention. Graphical user interface 2200 for team middle of the field wagering may be displayed, for example, in response to a user touching a team middle of the field icon, e.g., team middle of the field icon 1442 of FIG. 14. Display 2210 of graphical user interface 2200 indicates a team, e.g., an offensive team, selected for the position on a micro event. Graphical user interface 2200 comprises a team middle of the field display 2220. Team gain display 2220 indicates a payout factor for a wager that the offensive team will run a play, e.g., a run or a pass, to the middle of the field. For example, if the team runs up the middle, a wager will pay 10 times the amount wagered. Graphical user interface 2200 also comprises a pick amount field and potential score display 2225 associated with team middle of the field display 2220. The functions and operations of pick amount field and potential score display 2225 are similar to pick amount field 512 and potential score display 518 of FIG. 5. For example, pick amount field and potential score display 2225 displays and enables a selection of a wager amount on a play to the middle of the field, and a display of a potential score, factoring in a payout factor, should the team run a play to the middle of the field.

If the wagering game is real money fantasy wagering, a quarterback's player number will be displayed on display 2210 of graphical user interface 2200, along with text generally of the form, “Player number ### hands off/passes up the middle.”

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 2200 further comprises a cancel button 2271, a submit button 2272 and a “bet amount” field 2280. Bet amount field 2280 displays the total amount, e.g., in points, a user will bet, e.g., be at risk, if the bet is placed. Touching or otherwise indicating cancel button 2271 terminates the current creation of a bet. Touching or otherwise indicating submit button 2272 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

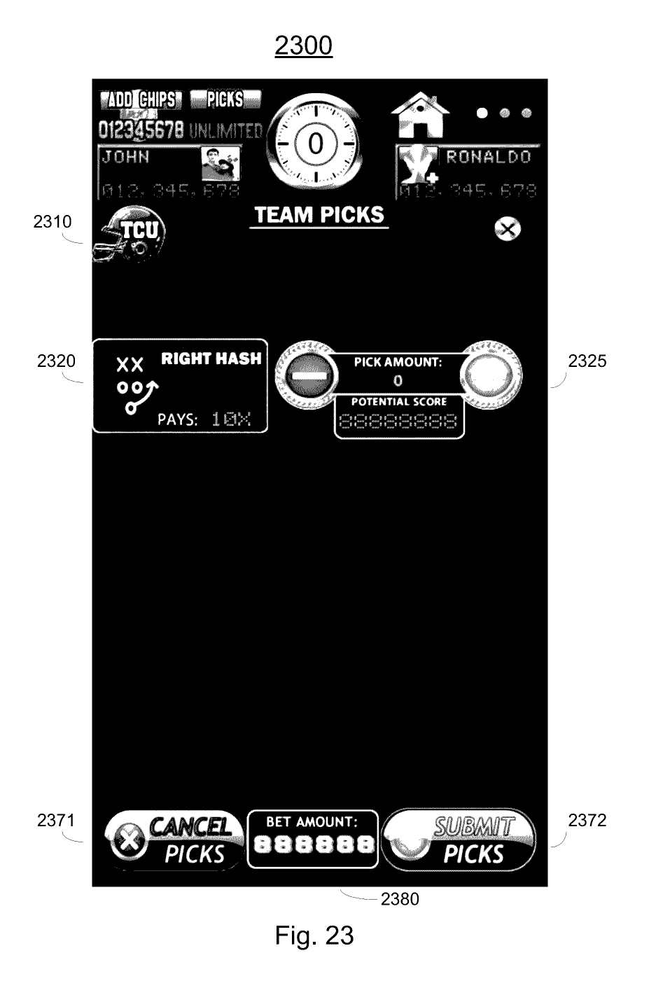

FIG. 23 illustrates an exemplary graphical user interface (GUI) 2300 for team right hash wagering, in accordance with embodiments of the present invention. Graphical user interface 2300 for team right hash wagering may be displayed, for example, in response to a user touching a team right hash icon, e.g., team right hash icon 1443 of FIG. 14. Display 2310 of graphical user interface 2300 indicates a team, e.g., an offensive team, selected for the position on a micro event. Graphical user interface 2300 comprises a team right hash display 2320. Team right hash display 2320 indicates a payout factor for a wager that the offensive team will run a play, e.g., a run or a pass, to the offensive right side of the field. For example, if the team runs to the right, a wager will pay 10 times the amount wagered. Graphical user interface 2300 also comprises a pick amount field and potential score display 2325 associated with team right hash display 2320. The functions and operations of pick amount field and potential score display 2325 are similar to pick amount field 512 and potential score display 518 of FIG. 5. For example, pick amount field and potential score display 2325 displays and enables a selection of a wager amount on a play to the right hash, and a display of a potential score, factoring in a payout factor, should the team run a play to the offensive right side of the field.

If the wagering game is real money fantasy wagering, a quarterback's player number will be displayed on display 2310 of graphical user interface 2300, along with text generally of the form, “Player number ### hands off/passes to the right.”

In accordance with embodiments of the present invention, the amounts displayed in a pick amount field and a potential score display may be in a real currency, e.g., New Zealand Dollars (“NZ$”), or in a virtual currency, e.g., social or fantasy points, or “chips.”

Graphical user interface 2300 further comprises a cancel button 2371, a submit button 2372 and a “bet amount” field 2380. Bet amount field 2380 displays the total amount, e.g., in points, a user will bet, e.g., be at risk, if the bet is placed. Touching or otherwise indicating cancel button 2371 terminates the current creation of a bet. Touching or otherwise indicating submit button 2372 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

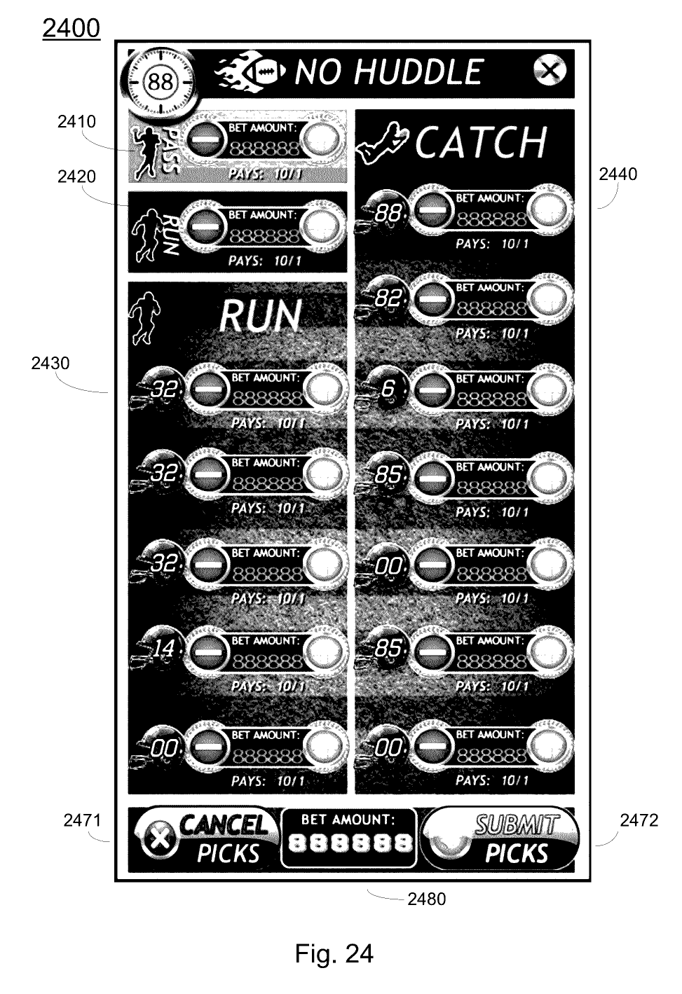

FIG. 24 illustrates an exemplary graphical user interface (GUI) 2400 for betting on a micro event when a duration between plays is decreased, e.g., in a “no huddle” situation, in accordance with embodiments of the present invention. Graphical user interface 2400 may be displayed, for example, responsive to a selection of a “no huddle” icon, e.g., no huddle icon 260 of FIG. 2. Graphical user interface 2400 comprises a team pass bet amount element 2410. Team pass bet amount element 2410 is used to place a wager amount that the next micro event will be any pass play, to any player. The pass may be a complete pass, or any pass result, including, for example, complete, incomplete or intercepted passes, in some embodiments. Team pass bet amount element 2410 displays a payout factor for the wager, and allows a player to select a bet amount, via a mechanism similar to pick amount field 512 of FIG. 5.

Similarly to team pass bet amount element 2410, graphical user interface 2400 comprises a team run bet amount element 2420. Team run bet amount element 2420 is used to place a wager amount that the next micro event will be any running play, by any player, including, for example, a quarterback. Graphical user interface 2400 comprises a plurality of specific player run bet amount elements, e.g., player run bet amount element 2430. Specific player run bet amount elements are used to place a wager amount that a specific player will run the ball on the next micro event. For example, selection of specific player run bet amount element 2430 represents a wager that player number 32 will run the ball. There may be player run bet amount elements for all players that typically run the ball, as well as a special player run bet amount element for player “00,” a wild card representing any player without a specific player run bet amount element.

If the wagering game is real money fantasy wagering, team pass bet amount element 2410 and team run bet amount element 2420 may not be presented, in some embodiments. If present, team pass bet amount element 2410 and team run bet amount element 2420 represent a pass or handoff, respectively, by the quarterback.

Graphical user interface 2400 comprises a plurality of specific player catch bet amount elements, e.g., player catch bet amount element 2440. Specific player catch bet amount elements are used to place a wager amount that a specific player will catch the ball on the next micro event. For example, selection of specific player catch bet amount element 2440 represents a wager that player number 88 will catch the ball. There may be player catch bet amount elements for all players that typically may receive catches, e.g., eligible receivers, as well as a special player catch bet amount element for player “00,” a wild card representing any player without a specific player catch bet amount element.

Graphical user interface 2400 further comprises a cancel button 2471, a submit button 2472 and a “bet amount” field 2480. Bet amount field 2480 displays the total amount, e.g., in points, a user will bet, e.g., be at risk, if the bet is placed. Touching or otherwise indicating cancel button 2471 terminates the current creation of a bet. Touching or otherwise indicating submit button 2472 causes the bet to be created. Generally, a bet must be submitted prior to the snap. A subsequent confirmation screen, e.g., “are you sure?”, may be presented, in accordance with embodiments of the present invention. It is appreciated that the bet may be subject to review by a third party, for example, the game provider, which may be an on-line casino, etc., prior to posting to other users for their acceptance.

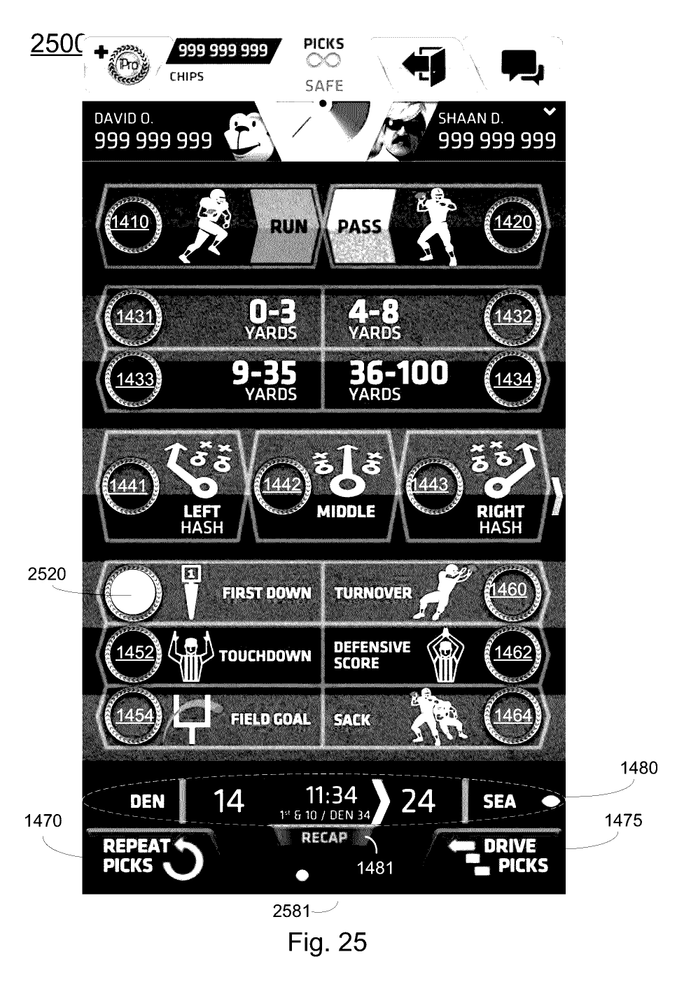

FIG. 25 illustrates an exemplary graphical user interface (GUI) 2500 for displaying a play recap, in accordance with embodiments of the present invention. Graphical user interface 2500 may be displayed, for example, responsive to a selection of a recap button, e.g., recap button 1481 of FIG. 14. Graphical user interface 2500 comprises a post wager marker 2520 to indicate any of the events that a user picked correctly on the particular play. For example, the user correctly selected a first down, as indicated by post wager marker 2520. A post wager marker, e.g., post wager marker 2520, may generally comprise a filled circle representing a golden coin, to indicate a correct pick. In the example of FIG. 25, the user either did not select other play attributes, e.g., run 1410 or pass 1420, or selected incorrectly, as evidenced by a lack of other post wager markers.

Graphical user interface 2500 also comprises a play result display 2581. Play result display 2581 replaces a scoreboard display, e.g., scoreboard display 1480 of FIG. 14. Play result display 2581 displays a textual summary of a play, e.g., player C. Washingotn received a pass from R. Nassib for 70 yards, and was tackled by R. Smith. Graphical user interface 2500 further comprises a play recap navigation button 2582. Touching or otherwise indicating play recap navigation button 2582 will toggle between graphical user interface 2500 and a pick history graphical user interface.

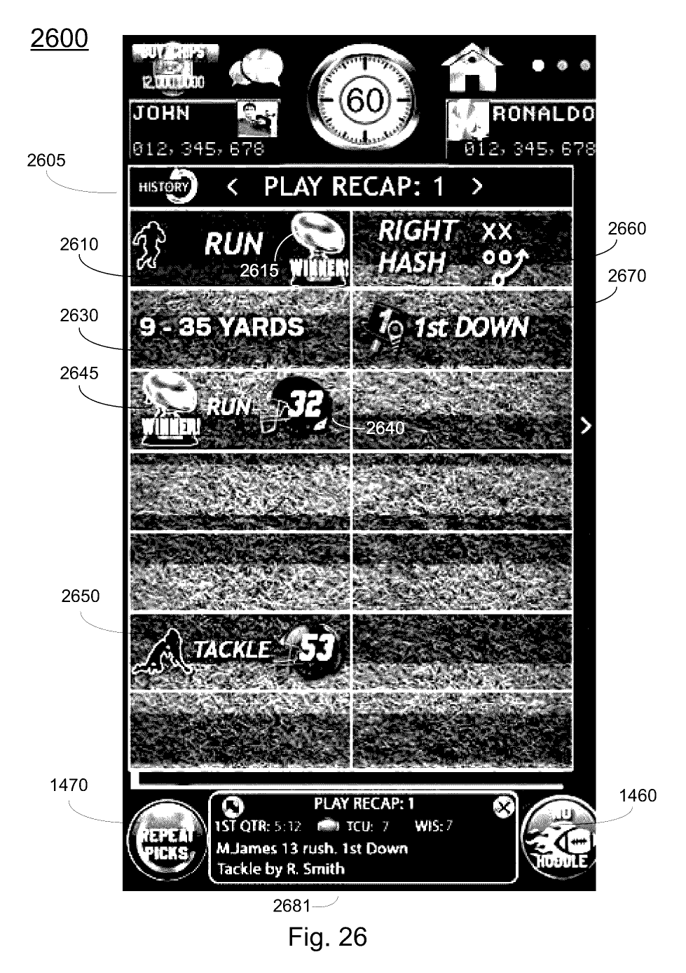

FIG. 26 illustrates an exemplary graphical user interface (GUI) 2600 for displaying a pick history, in accordance with embodiments of the present invention. Pick history graphical user interface 2600 comprises a play recap navigation pane 2605. A user may navigate among all historical plays by activating the left or right arrows of play recap navigation pane 2605. Pick history graphical user interface 2600 comprises a series of graphical play attributes that describe a play's characteristics in a manner similar to the way in which a user might select play attributes, for example, via graphical user interface 1400 of FIG. 14. It is appreciated that the play attributes of FIG. 26 are exemplary, and may change according to the results of each particular play and wager.

Pick history graphical user interface 2600 comprises a run display 2610, indicating that the play number 1 in the pick history was a running play. Run display 2610 comprises a winner icon 2615, e.g., a golden football, indicating that a user selected a running play for the particular play and won that wager. Pick history graphical user interface 2600 comprises a gain 9-35 yards display 2630, indicating that the play number 1 in the pick history gained between nine and thirty-five yards.

Pick history graphical user interface 2600 comprises a specific player display 2640, indicating that player number 32 ran the ball on play number 1 in the pick history. Specific player display 2640 comprises a winner icon 2645, e.g., a golden football, indicating that a user selected the specific player for the particular play and won that wager. Graphical user interface 2600 also comprises a play direction display 2660. Play direction display 2660 indicates that the run on play number 1 in the pick history was to the offensive right side of the field. Graphical user interface 2600 further comprises a 1st down display 2670. First down display 2670 indicates that play number 1 in the pick history achieved a first down.

Graphical user interface 2600 also comprises a play result display 2681. Play result display 2681 replaces a scoreboard display, e.g., scoreboard display 1480 of FIG. 14, for the play number 1 in the pick history. Play result display 2681 displays a textual summary of the play, e.g., player M. James ran for 13 yards, gained a first down, and was tackled by R. Smith.

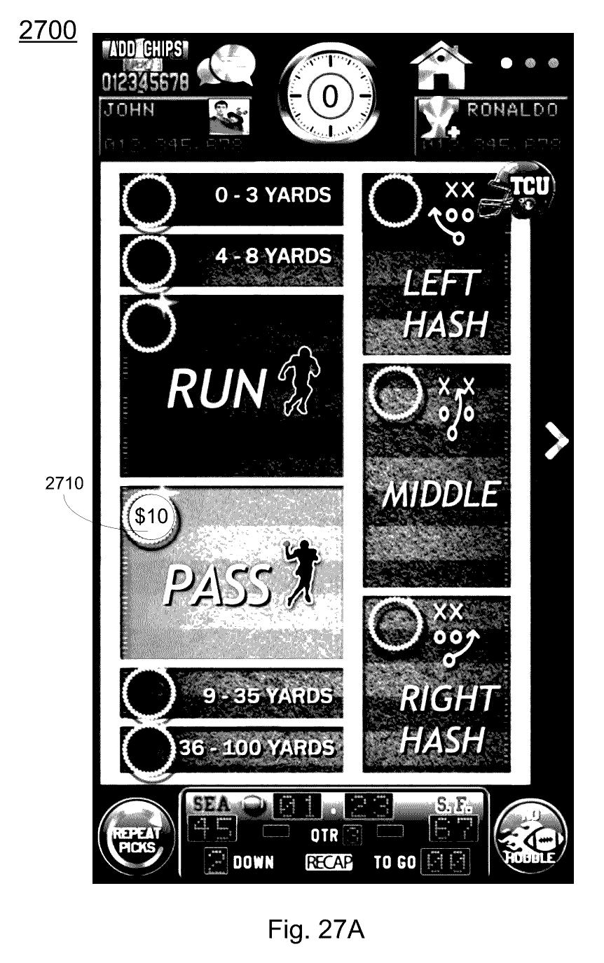

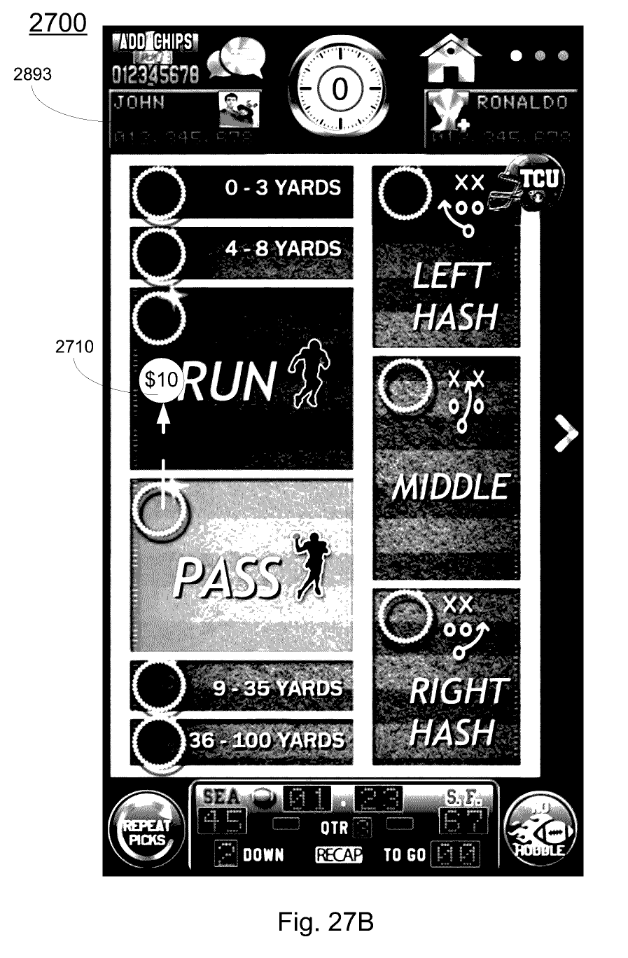

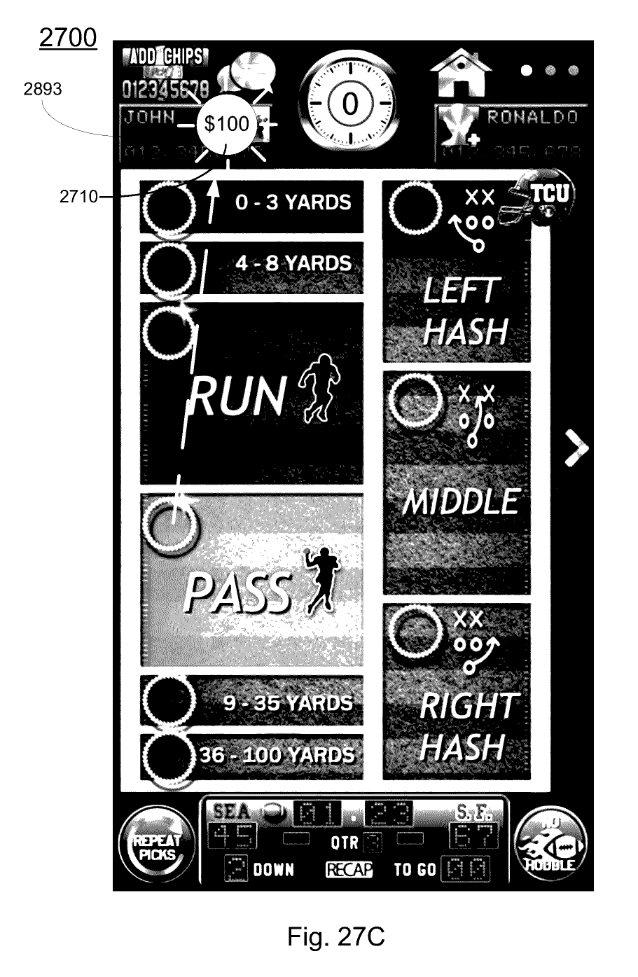

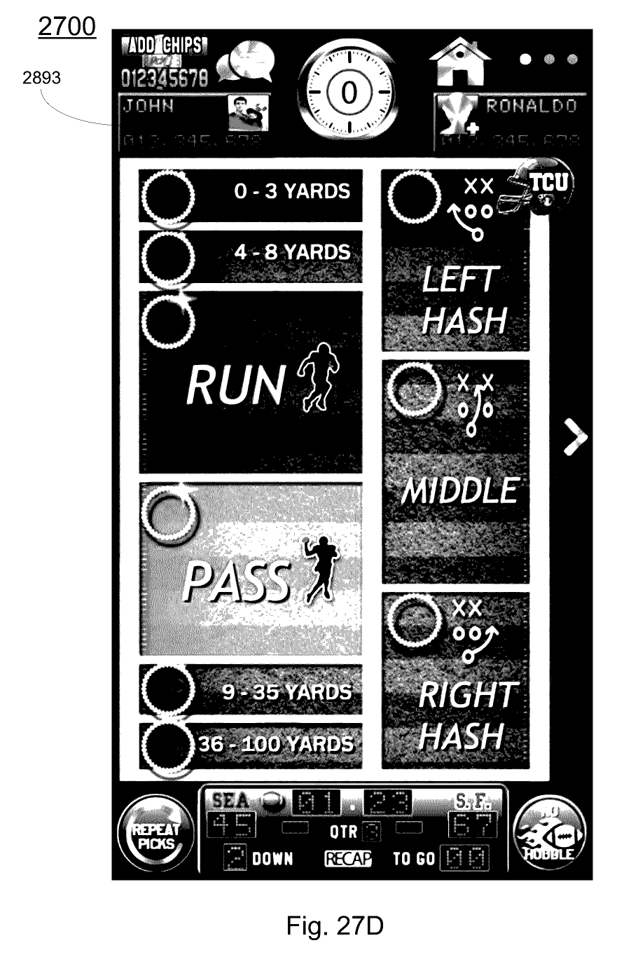

FIG. 27A illustrates a first condition of an exemplary graphical user interface (GUI) 2700 for displaying results of a wager, in accordance with embodiments of the present invention. Graphical user interface 2700 may be displayed, for example, responsive to touching a submit picks icon, e.g., submit picks icon 1572 of FIG. 15. Graphical user interface 2700 displays details of a wager on a micro event. Graphical user interface 2700 comprises a made bet icon 2710. Made bet icon 2710 indicates an amount bet on a particular event. For example, made be display 2710 indicates that a user bet $10 on a team pass play. Made bet icon 2710 may comprise a filled circle, e.g., of a golden color, in some embodiments.

FIG. 27B illustrates a second condition of an exemplary graphical user interface (GUI) 2700 for displaying results of a wager, in accordance with embodiments of the present invention. Responsive to the results of a micro event, e.g., a play has been run, made bet icon 2710 animates to present a user the results of the wager(s). If the bet was successful, made bet icon 2710 moves towards the display of a user's holdings, 2893.

FIG. 27C illustrates a third condition of an exemplary graphical user interface (GUI) 2700 for displaying results of a wager, in accordance with embodiments of the present invention. Responsive to the results of a micro event, e.g., a play has been run, made bet icon 2710 animates to present a user the results of the wager(s). In FIG. 27C, made bet icon 2710 has moved over the display of a user's holdings 2893. Made bet icon 2710 may display the bet's winnings based on any odds and/or multiplication factors, in some embodiments.

FIG. 27D illustrates a fourth condition of an exemplary graphical user interface (GUI) 2700 for displaying results of a wager, in accordance with embodiments of the present invention. The made bet icon 2710 has been removed, and the display of a user's holdings 2893 has been updated to reflect the bet's winnings.

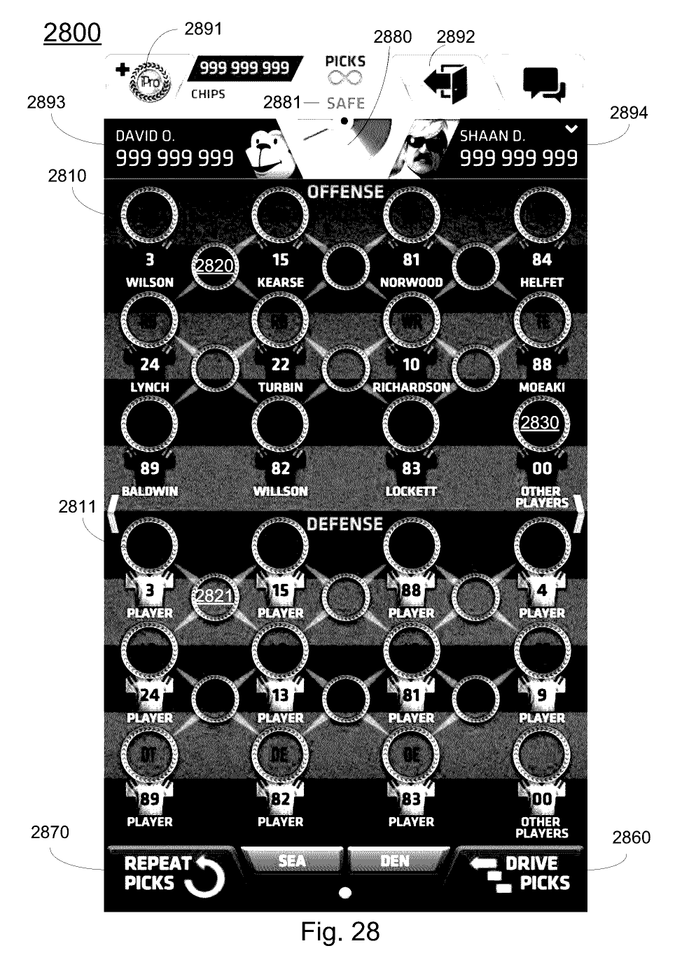

FIG. 28 illustrates an exemplary graphical user interface (GUI) 2800 for player wagering, in accordance with embodiments of the present invention. In the exemplary embodiment of FIG. 28, the display 2800 is configured for wagering on players' performance in micro events in a football contest. Embodiments in accordance with the present invention are well suited to wagering on micro events in other sporting contests. Approximately the top half of display 2800 is for taking positions on players and micro events related to the offensive team, while approximately the bottom half of display 2800 is for taking positions on players and micro events related to the defensive team. Display 2800 comprises a plurality of player icons, e.g., player icon 2810, comprising a circle outlining a player's position, e.g., “QB” for quarterback, “WR” for wide receiver, etc. The player's uniform number may also be shown on a jersey representation, as illustrated. The player's name may also be illustrated in visual association with a jersey and/or player icon. Generally, in graphical user interface 2800 and the graphical user interfaces to follow, a hollow, or unfilled circle represents a wagering opportunity. For example, wherever a hollow circle appears, e.g., player icon 2810, touching the hollow circle initiates a bet.

Each player icon represents the player with that number that plays at approximately that position. For example, the number 8 may generally correspond to a quarterback, punter, or place kicker. Selecting a player icon, e.g., by touching the icon, will initiate a subsequent display to select specific details of an upcoming play, e.g., a micro event, involving the player indicted by the player icon. Player icons, e.g., player icon 2811, are presented for defensive players, as well. An example wager on a defensive player and micro event may be on which player will tackle a ball carrier, or on which player will intercept a pass.

Display 2800 also comprises a plurality of player group icons, e.g., player group icon 2820. A player group icon comprises a circle among the offensive and defensive player icons that does not enclose a number. A player group icon represents a group of four players in closest proximity to the player group icon. For example, player group icon 2820 represents players 3, 15, 24 and 22. Selecting a player group icon, e.g., by touching the icon, will initiate a different display to select specific details of an upcoming play, e.g., a micro event, involving one or more of the players indicted by the player group icon. Player group icons, e.g., player group icon 2821, are presented for groups of defensive players, as well.

Player icon 2830, referring to player “00,” is a special case. Player icon 2830 does not refer to a player wearing number “00.” Rather, player icon 2830 refers to an offensive player other than the players indicated in the other offensive player icons. For example, the names and/or numbers in the player icons may refer to the players that start a game. In many sporting contests, including football, players may substitute, sometimes on a play-by-play basis. Accordingly, player icon 2830 represents any player, possibly a substitute player, that is not represented by another player icon, e.g., has a different number than a displayed player icon. Player icon 2830 is known as or referred to as a “wild card.”

Display 2800 also comprises a repeat picks field 2870. Repeat picks field 2870 may be used to repeat the wager on a play, e.g., a micro event, that was selected for the immediately preceding play. Display 2800 further comprises a drive picks icon 2860. Touching drive picks icon 1475 initiates a different version of a graphical user interface for use when a duration between plays is decreased, for example, when a multi-player interactive player might not have enough time to select details of a micro event according to graphical user interface 200 or graphical user interface 1400, e.g., when the offense is playing a “no huddle” style of play or when a user desires to make the same or similar picks for the duration of a “drive.” In general, the picks made within a drive picks graphical user interface(s) will last until the ball changes possession. In general, a user will be able to initiate a “drive picks” mode of game play during fourth down, punt return and/or kick-off return scenarios. In some embodiments, a user may be limited to initiation of drive picks to only such scenarios.

Display 2800 further comprises a countdown timer display 2880. Countdown timer display 2880 indicates a time remaining to complete selection of a position for a next micro event. Countdown timer display 2880 comprises a “gauge”-type display, with a “needle” indicator moving from a green region, indicating sufficient time remaining to enter wager selections, through a yellow region, indicating a decreased time remaining to enter wager selections, to a red zone, indicating that there is little or no time remaining to enter wager selections. In some embodiments, countdown timer display 2880 may reset to a play clock or shot clock, e.g., to a time remaining that is less than one minute, e.g., less than a full deflection of the needle indicator. Other visual attention grabbing mechanisms are well suited to use with countdown timer display 2880, including, for example, flashing elements of countdown timer display 2880, reversing text and/or graphics colors, and the like, in some embodiments.

Associated with countdown timer display 2880 is textual time remaining indication 2881. Textual time remaining indication 2881 provides a word-based indication of time remaining, e.g., “safe,” “short,” and/or “critical.” The text color of textual time remaining indication 2881may correspond to the color field of the needle in countdown timer display 2880. For example, when the needle is in the green, textual time remaining indication 2881 may be displayed in green. When the needle is in the yellow portion of 2880, textual time remaining indication 2881 may be displayed in yellow. When the needle is in the red, textual time remaining indication 2881 may be displayed in red. Other visual attention grabbing mechanisms are well suited to use with textual time remaining indication 2881, including, for example, flashing elements of textual time remaining indication 2881, reversing text and/or graphics colors, and the like, in some embodiments.

Display 2800 also comprises a display 2893 of a current player's holdings, e.g., in real currency or a virtual currency, e.g., fantasy or social points or chips. Display 2800 also comprises a display 2894 of an opponent's holdings. Display 2894 may display an opponent, from a group of opponents, with a highest score, in some embodiments. Touching display 2894 may present a list (not shown) of all opponents. Touching a particular opponent in such a list may cause that particular opponent to be displayed in display 2894, in some embodiments.

In addition, display 2800 comprises an add chips icon 2891 to add currency, e.g., real currency or a virtual currency, e.g., fantasy or social points or chips, to a player's holdings. Add chips icon 2891 may operate as a “rebuy” function, in some embodiments. In accordance with embodiments of the present invention, a user may not be able to add chips in all situations. For example, in a game with an entry fee, e.g., a fantasy game, users are generally not able to, or required to, submit a second entry fee, which may be the equivalent of adding chips in that circumstance. In addition, some games may limit a number of rebuys in a single wagering game. Further, user credit and/or user account balance considerations may prevent a user from adding chips. In such situations, add chips icon 2891 may not be presented, in accordance with embodiments of the present invention.

Further, display 2800 comprises a home icon 2892 to take a player to a home screen. Home icon 2892 may also display a symbolic indication of location within a multi-level graphical user interface, in some embodiments.

In accordance with embodiments of the present invention, the presence of a wager opportunity indicator, e.g., a yellow or golden wreath symbol, within a graphical user interface indicates a wager opportunity. For example, run icon 1410 of FIG. 14 is surrounded by a golden wreath symbol indicating a wager opportunity. For example, touching on or within the golden wreath symbol of run icon 1410 initiates, subject to subsequent confirmation and/or additional details, a wager that a next micro event will be a running play. In accordance with embodiments of the present invention, the presence of a wager opportunity indicator, e.g., a yellow or golden wreath symbol, indicates a wager opportunity. For example, wherever a wager opportunity indicator occurs, there is an opportunity to wager by touching on or within the wager opportunity indicator. In this novel manner, a user of a gaming application may benefit from improved navigation among numerous action selections, including, for example, requests for information, e.g., play recaps, actions related to real and/or virtual currency balances, and making wagers. There may be other wagering opportunities that are not indicated by a wager opportunity indicator, in some embodiments.

Player icon 2810 and player group icon 2820 of FIG. 28 also illustrate examples of wager opportunity indicators. For example, touching player icon 2810 initiates a wager concerning the quarterback, player number 3.

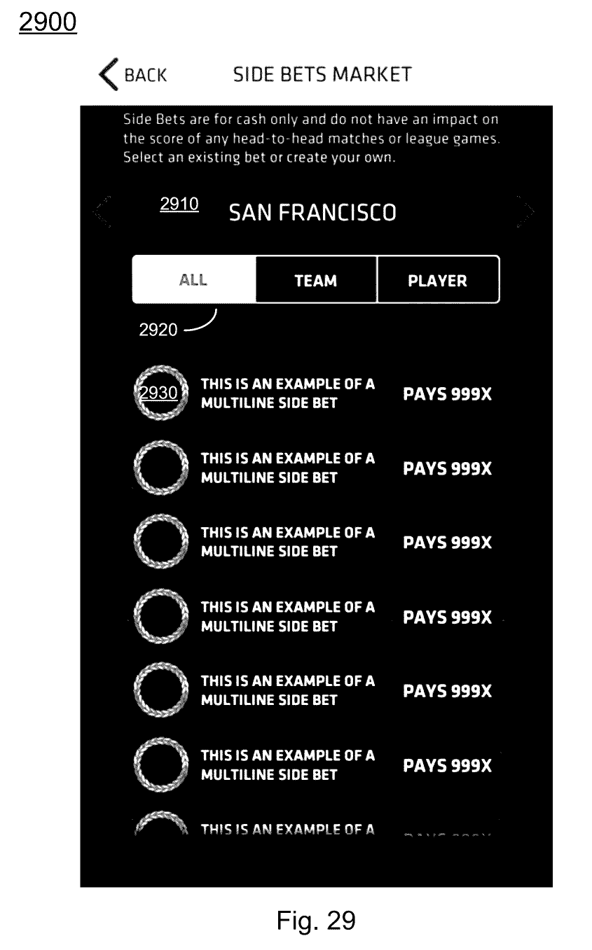

FIG. 29 illustrates an exemplary graphical user interface (GUI) 2900 for initiating a side bet, in accordance with embodiments of the present invention. Graphical user interface 2900 comprises a team selection field 2910. Team selection field may be used to select a team to be a subject of a side bet. Graphical user interface 2900 also comprises a category field, to select from available side bet categories related to the selected team. In the example of FIG. 29, a user has selected “all” categories.

Graphical user interface 2900 further comprises a plurality of side bets and associated side bet selection icons, e.g., side bet selection icon 2930. It is appreciated that a wager opportunity indicator surrounds side bet selection icon 2930. The wager opportunity indicator is a visual signal to a user that touching side bet selection icon 2930 initiates a wager.

Embodiments in accordance with the present invention provide graphical user interfaces for on-line gaming. In addition, embodiments in accordance with the present invention provide graphical user interfaces for on-line gaming that are substantially similar for various types of wagering on sporting events. Further, embodiments in accordance with the present invention provide graphical user interfaces for on-line gaming that are substantially similar for various types of wagering on sporting events.

Various embodiments of the invention are thus described. While the present invention has been described in particular embodiments, it should be appreciated that the invention should not be construed as limited by such embodiments, but rather construed according to the below claims.

What is claimed is:

1. A graphical user interface comprising:
a representation of a playing field;
a plurality of player icons on said representation for selecting to wager on a specific player, wherein each of said player icons comprises a player number;
a plurality of player group icons on said representation, located among a group of said player icons, for selecting to wager on a group of players represented by said group of said player icons, wherein said player group icon lacks a player number; and
a countdown timer for displaying a duration of time remaining to make a wager.

2. The graphical user interface of claim 1 wherein said countdown timer comprises an annular graphic display for indicating a time remaining as a filled fraction of an annular ring.

3. The graphical user interface of claim 1 further comprising:
a first down icon for selecting to wager on an offensive team achieving a first down.

4. The graphical user interface of claim 1 further comprising:
a field goal icon for selecting to wager on an offensive team kicking a field goal.

5. The graphical user interface of claim 1 further comprising:
a touchdown icon for selecting to wager on an offensive team scoring a touchdown.

6. The graphical user interface of claim 1 further comprising:
a turnover icon for selecting to wager on a defensive team recovering a turnover.

7. The graphical user interface of claim 1 further comprising:
a touchdown/safety icon for selecting to wager on a defensive team scoring.

8. The graphical user interface of claim 1 further comprising:
a sack icon for selecting to wager on a defensive team sacking a passer.

9. The graphical user interface of claim 1 further comprising:
a repeat pick icon for selecting to make the same wager as a prior wager.

10. The graphical user interface of claim 1 further comprising:
a no huddle icon to initiate a streamlined version of a graphical user interface for use when a duration between plays is decreased.

11. A graphical user interface for selecting team results of a micro event, said graphical user interface comprising:
a run icon for wagering a micro event will be a running play;
a pass icon for wagering said micro event will be a passing play;
a plurality of yardage gained icons for wagering yardage gained on said micro event; and
a plurality of play direction icons for wagering on a direction of said micro event.

12. The graphical user interface of claim 11 further comprising:
a countdown timer for displaying a duration of time remaining to make a wager.

13. The graphical user interface of claim 11 further comprising:
a scoreboard display for presenting information on the status of a sporting contest.

14. The graphical user interface of claim 11 wherein said plurality of yardage gained icons comprise yardage gained icons for 0-3 yards, 4-8 yards, 9-35 yards, and 36-100 yards.

15. The graphical user interface of claim 11 wherein said plurality of play direction icons comprise play direction icons for a play to the left hash, a play up the middle, and a play to the right hash.

16. The graphical user interface of claim 11 further comprising:
a no huddle icon to initiate a streamlined version of a graphical user interface for use when a duration between plays is decreased.

17. A graphical user interface for displaying a play recap, said graphical user interface comprising:
a post wager marker displayed over a selected betting icon, wherein selected said betting icon was selected to make a wager; and
a play result display summarizing a position taken on a micro event, wherein said play result display comprises a textual statement of said position taken on a micro event.

18. The graphical user interface of claim 17 wherein said post wager marker comprises a filled circle over said betting icon.

19. The graphical user interface of claim 17 further comprising:
a play recap navigation button to toggle between a play recap graphical user interface and a pick history graphical user interface.

20. The graphical user interface of claim 17 wherein, responsive to a swiping action, displaying a graphical user interface comprising a series of graphical play attributes that describe a wager's characteristics in a manner similar to a graphical user interface for selecting team results of a micro event.

21. A graphical user interface comprising:
a representation of a playing field;
a plurality of player icons on said representation for selecting to wager on a specific player; and
a plurality of player group icons on said representation, located among a group of said player icons, for selecting to wager on a group of players represented by said group of said player icons.

22. The graphical user interface of claim 21 further comprising:
a countdown timer for displaying a duration of time remaining to make a wager.

23. The graphical user interface of claim 21 further comprising:
a first down icon for selecting to wager on an offensive team achieving a first down.

24. The graphical user interface of claim 21 further comprising:
a field goal icon for selecting to wager on an offensive team kicking a field goal.

25. The graphical user interface of claim 21 further comprising:
a touchdown icon for selecting to wager on an offensive team scoring a touchdown.

26. The graphical user interface of claim 21 further comprising:
a turnover icon for selecting to wager on a defensive team recovering a turnover.

27. The graphical user interface of claim 21 further comprising:
a touchdown/safety icon for selecting to wager on a defensive team scoring.

28. The graphical user interface of claim 21 further comprising:
a sack icon for selecting to wager on a defensive team sacking a passer.

29. A graphical user interface comprising:
a wager opportunity indicator, wherein a presence of said wager opportunity indicator within said graphical user interface indicates an opportunity to place a wager.

30. The graphical user interface of claim 29 wherein said wager opportunity indicator comprises a gold-colored wreath symbol.

31. The graphical user interface of claim 29 wherein said wager opportunity indicator surrounds other symbology.

32. The graphical user interface of claim 29 wherein said wager opportunity indicator is operable to initiate a wager in a gaming application.
